(19) United States
(12) Patent Application Publication
(10) Pub. No.: US 2015/0263909 A1
(43) Pub. Date: Sep. 17, 2015

(54) SYSTEM AND METHOD FOR MONITORING A LARGE NUMBER OF INFORMATION PROCESSING DEVICES IN A COMMUNICATION NETWORK

(71) Applicant: FUJITSU LIMITED, Kawasaki-shi (JP)

(72) Inventor: Shuji Okubo, Yokohama (JP)

(21) Appl. No.: 14/595,575

(22) Filed: Jan. 13, 2015

(30) Foreign Application Priority Data
Mar. 12, 2014 (JP) 2014-048631

(51) Int. Cl. H04L 12/26

(52) U.S. Cl. CPC H04L 43/04; H04L 43/10

(57) ABSTRACT

An information processing system includes a plurality of monitoring target devices and a plurality of monitoring devices. A monitor device monitors one or more monitoring target devices allocated to the each monitoring device. The monitor device acquires monitor information from one or more monitoring target devices allocated to the monitoring device, and stores the acquired monitor information in a memory provided for the monitor device. When transmitting the monitor information stored in the memory to another monitoring device, the monitor device controls control transmission of the monitor information so that first monitor information that is the monitor information having a high priority and identified based on a type of the monitor information is transmitted in priority to second monitor information that is the monitor information other than the first monitor information.

### CROSS-REFERENCE TO RELATED APPLICATION

This application is based upon and claims the benefit of priority of the prior Japanese Patent Application No. 2014-048631, filed on Mar. 12, 2014, the entire contents of which are incorporated herein by reference.

### FIELD

The embodiments discussed herein are related to system and method for monitoring a large number of information processing devices in a communication network.

### BACKGROUND

An information processing system including a large number of information processing devices is provided with monitoring devices for monitoring individual information processing devices. For example, the monitoring devices acquire and store therein monitor information that is needed for monitoring and sequentially outputted by the information processing devices. When a failure log indicating occurrence of a failure in any of the information processing devices is contained in the monitor information, the monitoring device notifies the user of the occurrence of failure.

Upon receiving the notification, the user recognizes the occurrence of failure in the information processing device, and acquires the monitor information outputted by the information processing device, from the monitoring device. Then, the user analyzes the monitor information, investigates cause of the failure occurrence, and addresses the failure of the information processing device.

When a large number of information processing devices are the monitoring target, multiple monitoring devices share the responsibility of monitoring these many information processing devices. In a case where monitoring is performed by using multiple monitoring devices, each of the monitoring devices monitors pre-allocated information processing devices in a distributed manner (sometimes referred to as distribution monitoring).

To achieve the distribution monitoring, for example, an integrated monitoring device for integrally monitoring multiple monitoring devices is provided in an information processing system. The integrated monitoring device stores state information indicating the state of each information processing device (for example, failure state or normal state). The user operates the integrated monitoring device to refer to the state information stored in the integrated monitoring device and grasp general state of each information processing device. Further, the user operates the monitoring devices under the control of the integrated monitoring device to grasp state of the information processing device in detail.

A related technology is disclosed in Japanese Laid-open Patent Publication No. 2011-114471, Japanese Laid-open Patent Publication No. 2001-14186, and Japanese Laid-open Patent Publication No. 06-338923.

### SUMMARY

According to an aspect of the invention, an information processing system includes a plurality of monitoring target devices, and a plurality of monitoring devices. A monitoring device acquires monitor information from one or more monitoring target devices allocated to the monitoring device, and stores the acquired monitor information in a memory provided for the monitoring device. When transmitting the monitor information stored in the memory to another monitoring device, the monitoring device controls transmission of the monitor information so that a preferential piece of the monitor information identified based on a type of the monitor information is transmitted in priority to other pieces of the monitor information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

According to the aspect, it is possible to refer to monitor information from any of a plurality of monitoring devices, and to reduce influence of synchronization delay of monitor information among the monitoring devices.

### BRIEF DESCRIPTION OF DRAWINGS

FIG. 1 is a diagram illustrating an example of a system configuration of an information processing system, according to an embodiment;

FIG. 2 is a diagram illustrating an example of a hardware configuration of a monitoring device, according to an embodiment;

FIG. 3 is a diagram illustrating an example of a software configuration of first and second monitoring devices, according to an embodiment;

FIG. 4 is a diagram illustrating an example of configuration information in a table format, according to an embodiment;

FIG. 5 is a diagram illustrating an example of state information in a table format, according to an embodiment;

FIG. 6 is a diagram illustrating an example of event information in a table format, according to an embodiment;

FIG. 7 is a diagram illustrating an example of event holding device information in a table format, according to an embodiment;

FIG. 8 is a schematic diagram illustrating processing of user's reference to state information and event information of a monitoring target device, and information synchronization, according to an embodiment;

FIG. 9 is a schematic diagram illustrating processing of assuring the redundancy of monitoring devices, according to an embodiment;

FIG. 10 is a diagram illustrating an example of flowchart for monitor information synchronization processing, according to an embodiment;

FIG. 11 is a diagram illustrating an example of an operational flowchart for processing of adding a monitoring target device, according to an embodiment;

FIG. 12 is a diagram illustrating an example of an operational sequence for processing of adding a monitoring target device, according to an embodiment;

FIG. 13 is a schematic diagram illustrating a process of adding a monitoring target device, according to an embodiment;

FIG. 14 is a diagram illustrating an example of an operational flowchart for deleting a monitoring target device, according to an embodiment;

FIG. 15 is a diagram illustrating an example of an operational sequence for deleting a monitoring target device, according to an embodiment;

FIG. 16 is a diagram illustrating an example of an operational flowchart for equalizing allocation of monitoring target devices to monitoring devices, according to an embodiment;

FIG. 17 is a diagram illustrating an example of a synchronization sequence of event information, according to an embodiment;

FIG. 18 is a schematic diagram illustrating an example of adding a monitoring device, according to an embodiment;

FIG. 19 is a diagram illustrating an example of an operational sequence for adding a monitoring device, according to an embodiment;

FIG. 20 is a schematic diagram illustrating an example of deletion of a monitoring device, according to an embodiment; and

FIG. 21 is a diagram illustrating an example of an operational sequence for deletion of a monitoring device, according to an embodiment.

### DESCRIPTION OF EMBODIMENTS

As described above, when an integrated monitoring device is provided, the user is required to operate the integrated monitoring device and further the monitoring devices under the control thereof for addressing a failure of the information processing device, which is troublesome to the user.

Therefore, it is preferable to provide a device and a method capable of referring to the monitor information from any of multiple monitoring devices and reducing effects resulting from synchronization delay of the monitor information.

### First Embodiment

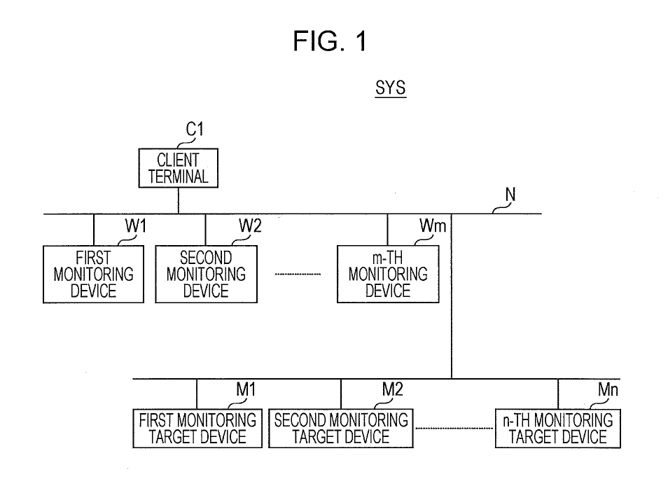

FIG. 1 is a diagram illustrating an example of a system configuration of an information processing system, according to an embodiment. In the description below, similar components are assigned similar reference numerals, and thereby description of similar components is omitted.

The information processing system SYS includes first to m-th monitoring devices W1 to Wm (small letter “m” represents an integer larger than 3), first to n-th monitoring target devices M1 to Mn (small letter “n” represents an integer larger than 3), and a client terminal C1 configured to operate the first to m-th monitoring devices W1 to Wm. The number of the monitoring devices and monitoring target devices is intended to be illustrative.

First to n-th monitoring target devices M1 to Mn are computers (for example, servers) configured to perform information processing. The servers include a physical server for constructing a virtual machine, a database server having database functions, a web server, and an application server. Here, the server may be not only a physical server, but also a virtual server.

The monitoring target to be monitored by the monitoring device may be not only a physical device (hardware) but also software operating on hardware.

First to m-th monitoring devices W1 to Wm acquire and manage state information indicating the state of first to n-th monitoring target devices, and event information indicating the event which has occurred in first to n-th monitoring target devices. Then, in response to a transmission request from the client terminal C1, the first to m-th monitoring devices W1 to Wm transmit state information and event information meeting the transmission request to the client terminal C1.

As illustrated in FIG. 1, provision of multiple monitoring devices is required because the information processing system SYS includes a large number of monitoring target devices (for example, more than 10,000 units), which are too many to be monitored by a single monitoring device. Therefore, each of the multiple monitoring devices monitors a group of monitoring target devices in a distributed manner (sometimes referred to as the distribution monitoring). For example, in the above example of 10,000 monitoring target devices, each of 10 monitoring devices monitors 1,000 (10,000/10) monitoring target devices in the distribution monitoring.

(Block Diagram of Monitoring Device)

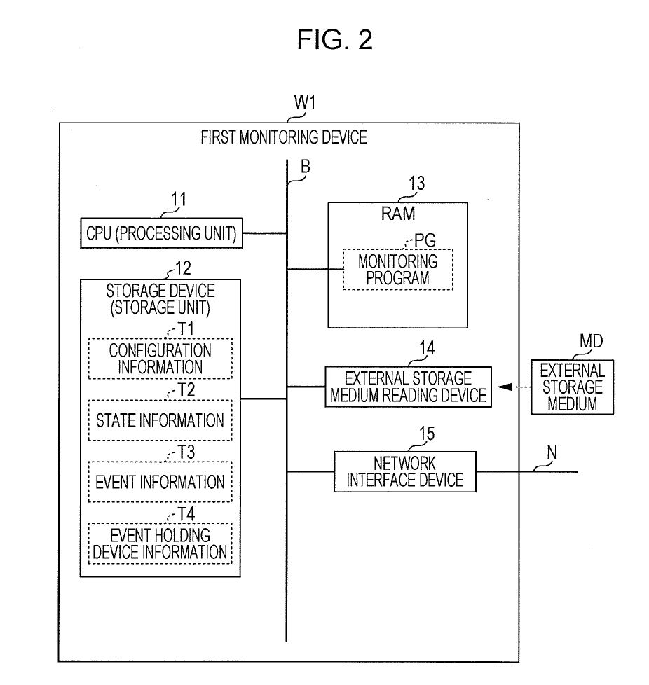

FIG. 2 is a diagram illustrating an example of a hardware configuration of a monitoring device, according to an embodiment. FIG. 2 illustrates, as an representative example of a monitoring device, a first monitoring device W1 of FIG. 1. Other monitoring devices (for example, second monitoring device W2, and m-th monitoring device Wm) have a similar configuration as the first monitoring device W1.

The first monitoring device W1 includes a CPU (processing unit) 11, storage device (storage unit) 12, a RAM 13, an external storage medium reading device 14, and a network interface device 15, which are connected to a bus B. The CPU is the abbreviation of “Central Processing Unit”, and the RAM is the abbreviation of “Random Access Memory”. Hereinafter, the CPU (processing unit) 11 may be referred to as the CPU 11, the storage device (storage unit) 12 as the storage 12, and the network interface device 15 as the network interface 15.

The CPU 11 is a central processing unit configured to control the entire first monitoring device W1. The storage 12 is a mass storage device, such as a hard disk drive, and a solid state drive.

The storage 12 stores configuration information T1, state information T2, event information T3, and event holding device information T4. The Event holding device information is also referred to as the holding device information. Detail of respective information stored by the storage 12 is described later. Further, the storage 12 stores an execution file of the monitoring program PG.

The RAM 13 temporarily stores data that are generated (calculated) in processing executed by the CPU 11, and at operations performed by the monitoring program PG. The RAM 13 is a semiconductor memory, such as dynamic random access memory (DRAM).

When the first monitoring device W1 is activated, the CPU 11 reads execution files of the monitoring program PG from the storage 12, load them into the RAM 13, and performs monitoring processing and various processing relating to the monitoring processing. The execution files may be stored in an external storage medium MD.

The external storage medium reading device 14 is a device configured to read data stored in the external storage medium MD. The external storage medium MD is, for example, a portable storage medium such as a compact disc read only memory (CD-ROM) and a digital versatile disc (DVD), and a portable non-volatile memory such as a USB memory.

The network interface 15 includes, for example, a network interface card (NIC) to provide an interface function to the network N.

As illustrated in FIG. 1 and FIG. 2, the information processing system SYS includes multiple devices (M1 to Mn) serving as the monitoring target, and multiple monitoring devices (W1 to Wn), each of which monitors allocated number of devices among the multiple devices.

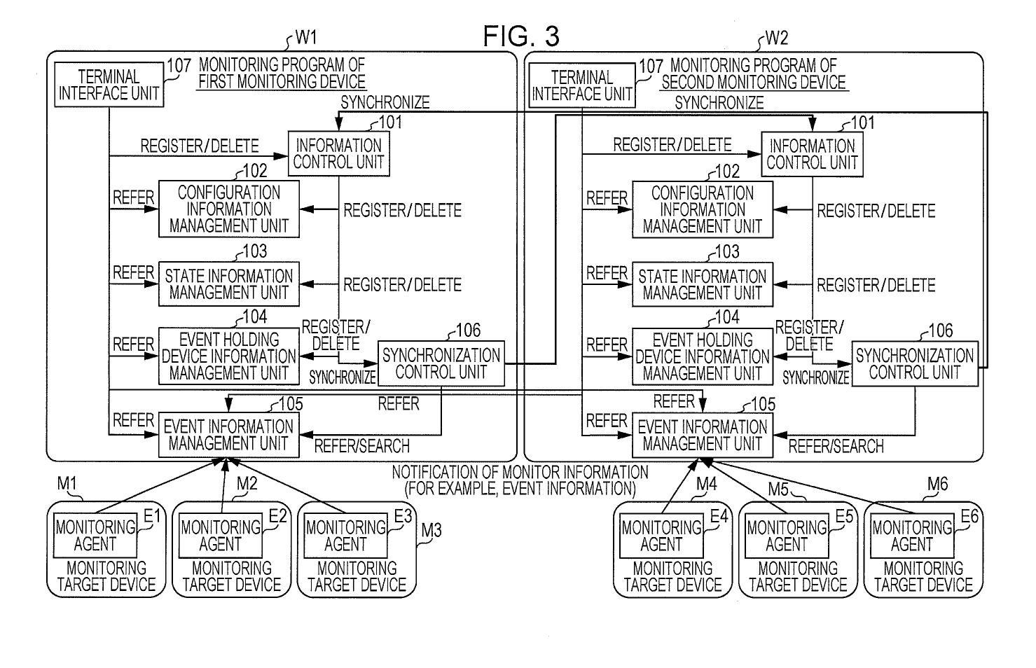

FIG. 3 is a diagram illustrating an example of a software configuration of first and second monitoring devices, according to an embodiment. FIG. 3 illustrates the first monitoring device W1 and the second monitoring device W2 of FIG. 2. Other monitoring devices (for example, m-th monitoring device Wm) than the first monitoring device W1 and the second monitoring device W2 also include a similar software configuration as the first monitoring device W1 and the second monitoring device W2.

The monitoring program PG of each of the first monitoring device W1 and the second monitoring device W2 includes an information control unit 101, a configuration information management unit 102, a state information management unit 103, an event holding device information management unit 104, an event information management unit 105, a synchronization control unit 106, and a terminal interface unit 107.

The information control unit is also referred to as an information control module, the configuration information management unit is also referred to as a configuration information management module, and the state information management unit is also referred to as a state information management module. The event holding device information management unit is also referred to as an event holding device information management module, the event information management unit is also referred to as an event information management module, the synchronization control unit is also referred to as a synchronization control module, and the terminal interface unit is also referred to as a terminal interface module.

The information control unit 101 performs control processing of the monitoring devices, and controls the configuration information management unit 102, the state information management unit 103, the event holding device information management unit 104, the event information management unit 105, the synchronization control unit 106, and the terminal interface unit 107. Further, the information control unit 101 performs communication with information control units 101 and synchronization control units 106 of other monitoring devices.

The information control unit 101 instructs the configuration information management unit 102 to register (or store) or delete configuration information. The information control unit 101 instructs the state information management unit 103 to register or delete state information. The information control unit 101 instructs the event holding device information management unit 104 to register or delete event holding device information. The information control unit 101 instructs the event information management unit 105 to register or delete event information. The information control unit 101 instructs the synchronization control unit 106 to synchronize various information.

The configuration information management unit 102 manages configuration information. The state information management unit 103 manages state information. The event holding device information management unit 104 manages event holding device information. The event information management unit 105 manages event information. The synchronization control unit 106 synchronizes configuration information, state information, and event information, which are stored in the monitoring device, with configuration information, state information, and event information, which are stored in other monitoring devices. In addition, the synchronization control unit 106 performs processing of referring to and searching event information of the synchronization target via the event information management unit 105.

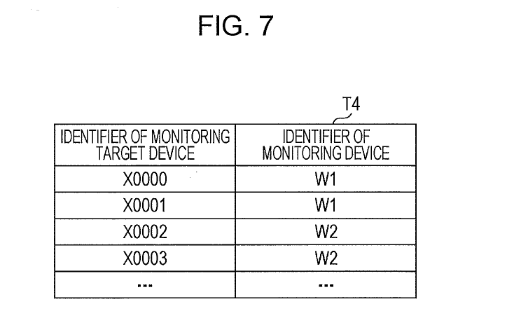

The terminal interface unit 107 performs various processing relating to communication processing with the client terminal C1. Operations of above components 101 to 107 will be described in detail with reference to FIG. 7 and subsequent drawings.

Monitoring target devices M1 to M6 illustrated on the lower side of FIG. 3 include monitoring agents E1 to E6, respectively. Each of the monitoring agents E1 to E6 is configured to notify monitor information (for example, event information) to a monitoring device which monitors the monitoring target device including the each monitoring agent. In the example of FIG. 3, monitoring agents E1 to E3 of monitoring target devices M1 to M3 notify monitor information to the first monitoring device W1. Monitoring agents E3 to E6 of monitoring target devices M3 to M6 notify monitor information to the second monitoring device W2. The first monitoring device W1 and the second monitoring device W2 transmit monitor information (for example, event information) to each other.

First to m-th monitoring devices W1 to Wm (see FIG. 1) manage pieces of information relating to the monitoring target devices by classifying them into three categories of information. The three categories of information include configuration information, state information, and event information stored by the storage 12 of FIG. 2.

(Configuration Information)

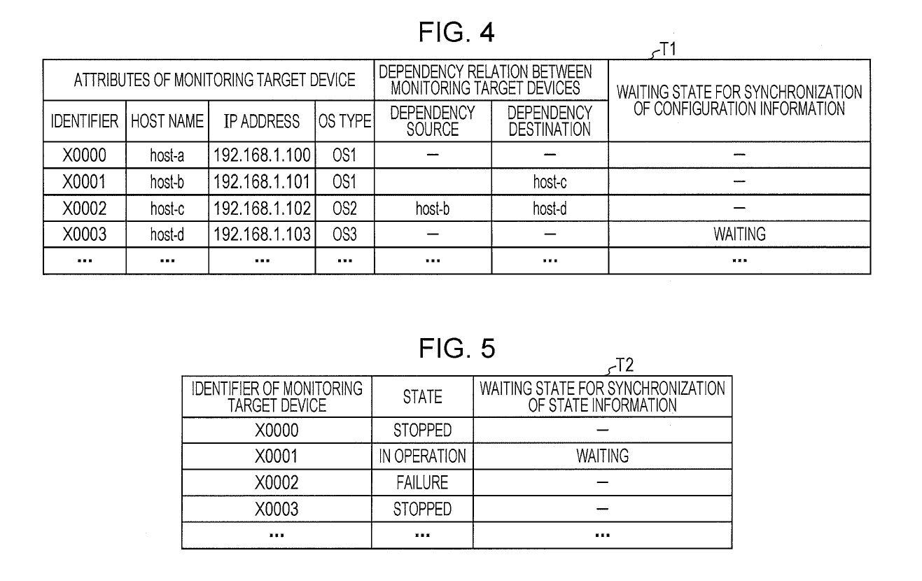

Configuration information is information indicating a configuration of the monitoring target device, and includes attributes of the monitoring target device, information indicating a dependency relation between monitoring target devices, and information indicating the waiting state for synchronization of configuration information. FIG. 4 is a diagram illustrating an example of configuration information in a table format, according to an embodiment.

Attributes of the monitoring target device indicate an identifier of the monitoring target device, a host name of the monitoring target device, an IP address set to the monitoring target device, and type of the OS (Operating System) running on the monitoring target device.

Information indicating dependency relation between monitoring target devices (hereinafter, referred to as the dependency relation between monitoring target devices, as appropriate) indicates that a first monitoring target device (a dependency source) depends on a second monitoring target device (a dependency destination). This dependency indicates, for example, that operation of the second monitoring target device is desired for operation of the first monitoring target device.

This dependency is described specifically. When the first monitoring target device M1 is a virtual machine, and the second monitoring target device M2 is a physical server for activating the virtual machine, operation of the second monitoring target device M2 (physical machine) is desired for operation of the first monitoring target device M1 (virtual machine). Therefore, a dependency relation exists between the first monitoring target device M1 (virtual machine) and the second monitoring target device M2 (physical machine).

Assume that the first monitoring target device M1 is an application. As illustrated in FIG. 1, the monitoring target may be an application. In the above assumption, an application of the monitoring target is described as a device for convenience of explanation. Then, assume that the second monitoring target device M2 is a server for activating the application.

Operation of the second monitoring target device M2 (server) is desired for operation of the application (first monitoring target device M1). Therefore, a dependency relation exists between the first monitoring target device M1 (application) and the second monitoring target device M2 (server).

The above dependency relation may also exist between user applications (between the bank account management application and other bank's remittance application).

Information indicating the waiting state for synchronization of configuration information is information indicating the synchronization progress status when a monitoring device (synchronization source monitoring device) synchronizes configuration information with the other monitoring device (synchronization destination monitoring device).

Configuration information T1 of FIG. 4 includes a field for storing attributes of the monitoring target device, a field for storing dependency relation between monitoring target devices, and a field for storing the waiting state for synchronization of configuration information.

The configuration information management unit 102 of the monitoring device stores (registers) configuration information of one monitoring target device in one line as illustrated in configuration information T1. Specifically, the configuration information management unit 102 stores the attributes of the monitoring target device, the dependency relation between monitoring target devices, and the waiting state for synchronization of configuration information in association with each other. Configuration information of one monitoring target device (configuration information of one line) is one configuration information record.

The attribute field of monitoring target device includes an identifier field, a host name field, an IP address field, and an OS type field. The identifier field stores the identifier of the monitoring target device. The host name field stores the host name of the monitoring target device. The IP address field stores the IP address set to the monitoring target device. The OS type field stores type of the OS operating on the monitoring target device.

The field of the dependency relation between monitoring target devices includes a dependency source field, and a dependency destination field. In the above relation between the first monitoring target device and the second monitoring target device, assume a case where operation of the second monitoring target device is desired for operation of the first monitoring target device. In this assumption, the first monitoring target device is a dependency source monitoring target device, and the second monitoring target device is a dependency destination monitoring target device. The dependency source field stores the host name of the first monitoring target device, and the dependency destination field stores the host name of the second monitoring target device.

The field of the waiting state for synchronization of configuration information stores synchronization progress state when a monitoring device synchronizes configuration information with the other monitoring device. For example, when the state is “synchronization waiting”, “waiting” is stored, and when the state is other than “synchronization waiting”, “-” (hyphenation) is stored.

In the example of FIG. 4, the configuration information management unit 102 of the monitoring device stores, in one line of configuration information T1, the host name “host-c” of a monitoring target device identified by the identifier X0002, the IP address “192.168.1.102” of the monitoring target device, and type of the OS “OS2” of the monitoring target device. Then, the monitoring device stores, in one line of the above configuration information T1, the dependency source “host-b” of the monitoring target device, the dependency destination “host-d” of the monitoring device, and the waiting state for synchronization “-” (other than synchronization waiting) of the configuration information.

(State Information)

The state information is information indicating the state of the monitoring target device. The state information includes an identifier of the monitoring target device (for example, host name, internal identification number, etc.), a state of the monitoring target device (for example, “in operation”, “stopped”, “failure”, etc.), and a waiting state for synchronization of state information. FIG. 5 is a diagram illustrating an example of state information in a table format, according to an embodiment.

When there is no response by, for example, Internet Control Message Protocol (ICMP), i.e. a ping response from the monitoring target device, the state information management unit 103 of the monitoring device determines that the monitoring target device is in the stopped state and stores information on that effect. In addition, the state information management unit 103 of the monitoring device determines, based on a failure message contained in the event information outputted by the monitoring target device, that a failure has occurred in the monitoring target device, and stores information on that effect.

Information indicating the waiting state for synchronization of configuration information is information indicating the synchronization progress status when a monitoring device synchronizes configuration information with the other monitoring device (at the synchronization destination).

State information T2 of FIG. 5 includes an identifier field of the monitoring target device, a state field, and a synchronization waiting field of state information.

The state information management unit 103 of the monitoring device stores (registers) state information of one monitoring target device in one line as illustrated in state information T2. Specifically, the state information management unit 103 stores the identifier of one monitoring target device, the state of one monitoring target device, and the waiting state for synchronization of configuration information in association with each other. State information of one monitoring target device (state information of one line) is stored in one state information record.

The identifier field of the monitoring target device stores the identifier of the monitoring target device. The state field stores the state of the monitoring target device. The field of the waiting state for synchronization of state information stores synchronization progress state when a monitoring device synchronizes state information with the other monitoring device. When the state is “synchronization waiting”, “waiting” is stored, and when the state is other than “synchronization waiting”, “-” (hyphenation) is stored.

In the example of FIG. 5, the state information management unit 103 of the monitoring device stores, in one line of state information T2 described above, for example, the state “failure” of the monitoring target device identified with the identifier X0002, and the waiting state for synchronization “-” of state information (other than synchronization waiting).

(Event Information)

The event information is information indicating an event which has occurred in the monitoring target device. The monitoring agent (see FIG. 2) operating on the monitoring target device transmits event information to a predetermined monitoring device.

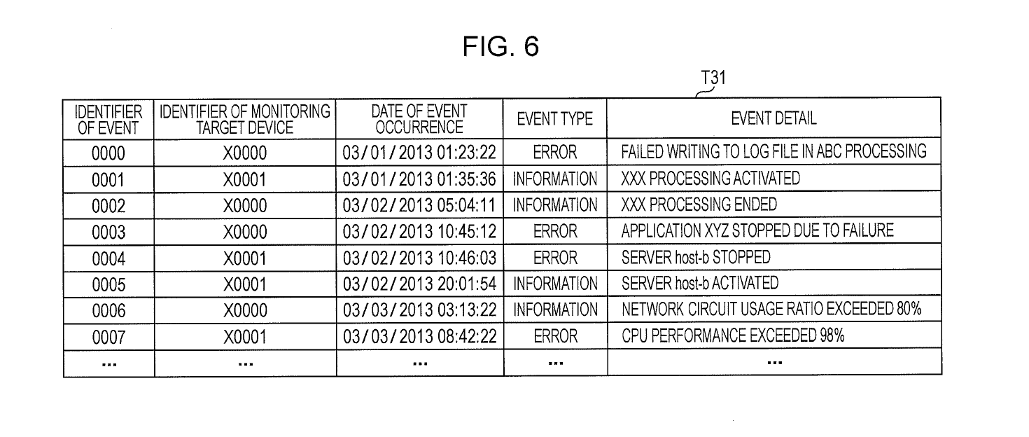

Event information includes the event identifier (internal identification number, etc.), the identifier (host name, internal identification number, etc.) of the monitoring target device in which the event has occurred, date when the event has occurred, the event type, and the event detail. FIG. 6 is a diagram illustrating an example of event information in a table format, according to an embodiment.

Information of event information other than the even identifier, that is, the monitoring target device identifier, the event occurrence date, the event type, and the event detail, are, for example, included in a message which the monitoring agent of the monitoring target device notifies to the monitoring device. The event detail is, for example, a log outputted by an OS or an application operating on the monitoring target device. Event type is information characterizing the event detail, and the event types include, for example, an error (in other words, failure), a warning, and information other than the error and warning.

Event information T31 of FIG. 6 includes an event identifier field, a monitoring target device identifier field, an event occurrence date field, an event type field, and an event detail field.

The event information management unit 105 of the monitoring device stores (registers) one event information in one line as illustrated in event information T31. Specifically, the event information management unit 105 stores the event identifier, the monitoring target device identifier, the event occurrence date, the event type, and the event detail in association with each other. Event information of one event (event information of one line) is stored in one event information record.

The event identifier field stores the identifier of the event. The monitoring target device identifier field stores the identifier of the monitoring target device in which an event has occurred. The event occurrence date field stores the year, month, day, hour, minute, and second when an event has occurred. The event type field stores the type of the event. The event detail field stores the detail of the event.

In the example of FIG. 6, the event information management unit 105 of the monitoring device stores, in one line of event information T31 described above, that an event identified with the identifier “0000” has occurred in a monitoring target device identified with the identifier “X0000” at “2013/03/01 01:23:22”, and the type of the event is “error”. Further, the event information management unit 105 of the monitoring device stores, in one line of the event information T31 described above, the event detail of “writing into the log file has failed during ABC processing”.

By referring to the event information stored by the monitoring device, the user is able to recognize the event which has occurred in a monitoring target device and the detail thereof, and to grasp the state of the monitoring target device. The user is, for example, an administrator of the information processing system SYS.

(Event Holding Device Information)

The monitoring device has event holding device information. The event holding device information is information indicating a monitoring device in which event information is stored (or held). The monitoring device identifies a monitoring device storing event information, based on the event holding device information.

The event holding device information includes an identifier (host name, internal identification number, etc.) for identifying a device to be monitored, and an identifier (host name, internal identification number, etc.) for identifying a monitoring device monitoring this device. The monitoring device monitoring this device is a monitoring device which stores event information of the device.

FIG. 7 is a diagram illustrating an example of event holding device information in a table format, according to an embodiment. The event holding device information T4 includes a monitoring target device identifier field, and a monitoring device identifier field. The monitoring target device identifier field stores an identifier of the monitoring target device. The monitoring device identifier field stores the identifier of the monitoring device storing event information of the monitoring target device.

The event holding device information management unit 104 of the monitoring device stores (registers) one event holding device information in one line as illustrated in the event holding device information T4. Specifically, the event holding device information management unit 104 stores the identifier of the monitoring target device and the identifier of the monitoring device storing event information of the monitoring target device, in association with each other. In other words, the event holding device information management unit 104 stores the identifier of the monitoring device and the identifier of the monitoring target device monitored by the monitoring device, in association with each other. Event holding device information of one monitoring target device (event holding device information of one line) is stored in one event holding device information record.

In the example of FIG. 7, the event holding device information management unit 104 of the monitoring device stores, in one line of the event holding device information T4 mentioned above, the identifier “X0000” of the monitoring target device, and the identifier “W1” of the monitoring device storing event information of the monitoring target device. The identifier of the monitoring device is same as the referential numeral (such as, for example, “W1” and “W2”) of the monitoring device of FIG. 1.

The information processing system SYS uses multiple monitoring devices for monitoring a large number of monitoring target devices as illustrated in FIG. 1. Here, first to m-th monitoring devices W1 to Wm each store state information of all the monitoring target devices. The stored state information allows the user to determine the state of all the monitoring target devices by using any of monitoring devices.

On the other hand, since event information contains a large amount of information, multiple monitoring devices store event information of monitoring target devices in a distributed manner. For example, when the information processing system SYS includes 10 units of monitoring devices for 10,000 units of monitoring target devices, one monitoring device stores event information of 1,000 monitoring target devices.

First to m-th monitoring devices W1 to Wm store, as event holding device information, information indicating in which one of the monitoring devices event information of the monitoring target device is stored.

(Reference to State Information and Event Information, and Information Synchronization)

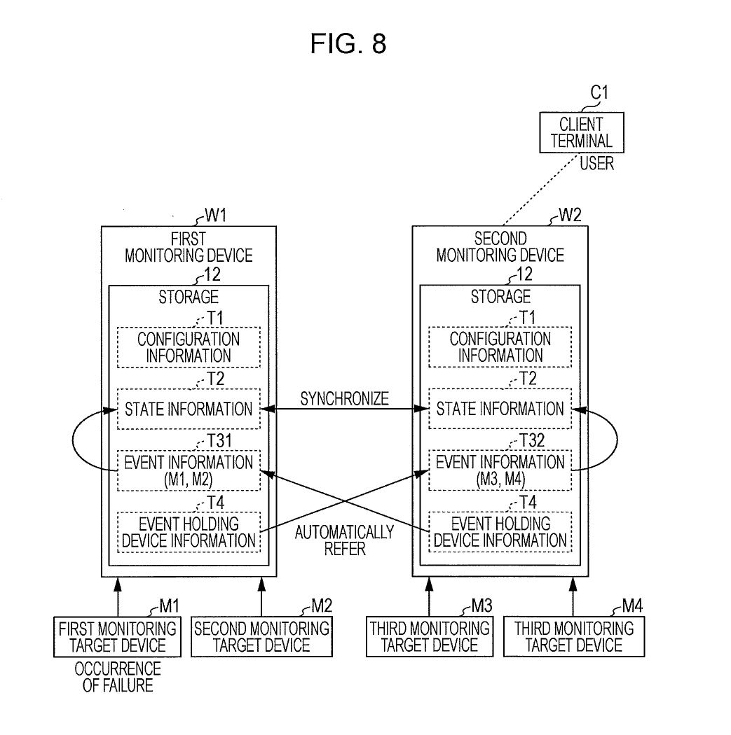

FIG. 8 is a schematic diagram illustrating processing of user's reference to state information and event information of a monitoring target device, and information synchronization, according to an embodiment. The first monitoring device W1 monitors the first monitoring target device M1 and the second monitoring device M2, and the second monitoring device W2 monitors the third monitoring target device M3 and the fourth monitoring target device M4. In other words, the first monitoring target device M1 and the second monitoring target device M2 notify event information to the first monitoring device W1, and the third monitoring target device M3 and the fourth monitoring target device M4 notify event information to the second monitoring device W2.

The first monitoring device W1 has configuration information T1, state information T2, event holding device information T4, and event information T31. The configuration information T1 includes configuration information of the first monitoring target device M1 through the fourth monitoring target device M4. The state information T2 includes state information of the first monitoring target device M1 through the fourth monitoring target device M4.

The event holding device information T4 is information indicating that a monitoring device storing event information of first and second monitoring target devices M1 and M2 is the first monitoring device W1, and a monitoring device storing event information of third and fourth monitoring target devices is the second monitoring device W2. The event information T31 is information including event information of the first monitoring target device M1 and the second monitoring target device M2 (see event information (M1, M2)).

The second monitoring device W2 has configuration information T1, state information T2, event holding device information T4, and event information T32. The event information T32 is information including event information of the third monitoring target device M3 and the fourth monitoring target device M4 (see event information (M3, M4)).

(Reference to State Information)

The state information contains a small amount of information as illustrated in FIG. 5. Therefore, even if all monitoring devices (first to m-th monitoring devices W1 to Wm) in the information processing system SYS store state information of all monitoring target devices (first to n-th monitoring target devices M1 to Mn), there may be less possibility of pressing the storage capacity within the monitoring devices.

Accordingly, in order to reduce processing of the monitoring device for accessing to the other monitoring device to acquire state information of a monitoring target device monitored by the monitoring device, each of all monitoring devices (first to m-th monitoring devices W1 to Wm) stores state information of all monitoring target devices (first to n-th monitoring target devices M1 to Mn).

Hereinafter, description will be given of reference to the state information. For example, the user intending to grasp the state of the first monitoring target device M1 operates the client terminal C1 to access, for example, to the second monitoring device W2 (see dotted line in FIG. 8). Then, the user operates the client terminal C1 to transmit a state information acquisition command of the first monitoring target device M1 including the identifier (for example, “X0000”) of the first monitoring target device M1 to an information control unit 101 via a terminal interface unit 107 of the second monitoring device W2. The command is also referred to as the signal.

The information control unit 101 of the second monitoring device W2 receives this command, and identifies state information including the identifier of the first monitoring target device M1 out of the state information T2 stored in the second monitoring device W2.

The information control unit 101 of the second monitoring device W2 transmits the received state information of the first monitoring target device M1 to the client terminal C1 via the terminal interface unit 107. The client terminal C1 displays the received state information of the first monitoring target device M1 to the user via the display device (not illustrated).

As described above, the user is able to acquire state information of the first monitoring target device M1 by accessing a monitoring device (for example, second monitoring device W2) monitoring other monitoring target devices than the first monitoring target device M1, but without being aware that the first monitoring target device M1 is monitored by the first monitoring device W1.

(Reference to Event Information)

Here, having recognized that a failure has occurred in the first monitoring target device M1, the user operates the client terminal C1 to access, for example, the second monitoring device W2 (see dotted line of FIG. 8). Then, the user operates the client terminal C1 to transmit an event information acquisition command of the first monitoring target device M1 including an identifier (for example, “X0000”) of the first monitoring target device M1 to the information control unit 101 via the terminal interface unit 107 of the second monitoring device W2. The information control unit 101 receives this command, and identifies, based on the event holding device information T4, the identifier (for example, W1) of a monitoring device storing event information of the first monitoring target device M1, that is, an identifier of a monitoring device associated with the identifier of the first monitoring target device M1.

When the identifier is not an identifier of the second monitoring device W2, the information control unit 101 of the second monitoring device W2 transmits an event information acquisition command of the first monitoring target device M1 including the identifier (for example, “X0000”) of the first monitoring target device M1 to the information control unit 101 of the first monitoring device W1. The information control unit 101 of the first monitoring device W1 receives this command, and identifies, based on the event holding device information T4, the identifier (for example, W1) of a monitoring device associated with the identifier of the first monitoring target device M1.

When the identifier is an identifier of the first monitoring device W1, the information control unit 101 of the first monitoring device W1 identifies event information of the first monitoring target device M1 including the identifier “X0000” of the first monitoring target device M1 out of the event information T31 stored in the first monitoring device W1. The information control unit 101 of the first monitoring device W1 transmits the identified event information to the information control unit 101 of the second monitoring device W2.

The information control unit 101 of the second monitoring device W2 transmits the received event information of the first monitoring target device M1 to the client terminal C1 via the terminal interface unit 107. The client terminal C1 displays the received event information of the first monitoring target device M1 to the user via the display device (not illustrated).

As described above, the user can acquire event information of the first monitoring target device M1 by accessing a monitoring device (for example, second monitoring device W2) monitoring other monitoring target devices than the first monitoring target device M1, but without being aware that the first monitoring target device M1 is monitored by the first monitoring device W1. Then, the user is able to investigate the failure of the first monitoring target device M1 in detail by referring to the acquired event information.

(Information Synchronization)

As described above in the reference to state information, synchronization processing described below is performed for each of all monitoring devices (first to m-th monitoring devices W1 to Wm) to hold same state information of all monitoring target devices (first to n-th monitoring target devices M1 to Mn).

That is, when state information stored in a monitoring device (for example, second monitoring device W2) is updated by the user manually or automatically, the monitoring device reflects the updated content on state information stored in other monitoring devices. In other words, a monitoring device synchronizes state information stored in other monitoring devices with the updated content.

Automatic updating of state information will be described. The state information management unit 103 of the monitoring device updates (also referred to as “perform state transition”) information of the monitoring target device based on event information notified by the monitoring target device.

For example, when one event information record including the event type “error” is notified by a monitoring target device, the state information management unit 103 of the monitoring device changes the state contained in the state record of the monitoring target device, which is stored in the state information stored in the monitoring device, to “failure”. The monitoring device transmits the updated content of the state information to other monitoring devices and synchronizes the state information for the updated content with other monitoring devices.

For example, a failure occurs in the first monitoring target device M1 of FIG. 8 (see “failure occurrence” at the lower side of the first monitoring target device M1 in FIG. 8). The first monitoring target device M1 notifies the event information record including the event type “error” to the first monitoring device W1. The information control unit 101 of the first monitoring device W1 receives and transmits the event information record to the state information management unit 103 and the event information management unit 105. The event information management unit 105 adds an event information record identifier to the event information record which is then included in the event information T31 stored in the first monitoring device W1. The state information management unit 103 changes the state in the state information T2, which is associated with an identifier (for example, “X0000”) of a monitoring target device contained in the event information record, to “failure”.

The information control unit 101 of the first monitoring device W1 transmits a state synchronization command of the first monitoring target device, which includes the state record (state “failure”) having an identifier (for example, “X0000”) of the first monitoring target device, to another monitoring device within the information processing system SYS.

As an example of the another monitoring device within the information processing system SYS, the second monitoring device W2 of FIG. 8 is illustrated. Upon receiving this state synchronization command, the information control unit 101 of the second monitoring device W2 transmits the state synchronization command to the state information management unit 103. The state information management unit 103 receives the state synchronization command, and changes the waiting state for synchronization, which is associated with an identifier of the first monitoring target device M1 in the state information T2 stored in the second monitoring device W2, from “-” to “waiting”. Further, the state information management unit 103 changes the state, which is associated with the identifier of the first monitoring target device M1 in the state information T2 stored in the second monitoring device W2, from “normal” to “failure” (synchronization of state information). After changing the state, the state information management unit 103 changes waiting state for synchronization, which is associated with the identifier of the first monitoring target device M1 in the state information T2 stored in the second monitoring device W2, from “waiting” to “-”.

Next, manual updating of state information will be described. Assume that after a failure occurs in the first monitoring target device M1 of FIG. 8, the user completes trouble restoration by repair to the failure or the like. The user operates the client terminal C1 to transmit an state change command of the first monitoring target device M1, which includes an identifier (for example, “X0000”) and the state “normal” of the first monitoring target device M1 for which trouble restoration has completed, to the information control unit 101 via the terminal interface unit 107 of the second monitoring device W2.

The information control unit 101 of the second monitoring device W2 transmits the state change command to the state information management unit 103. The state information management unit 103 receives the state change command, and changes the waiting state for synchronization, which is associated with the identifier of the first monitoring target device M1 in the state information T2, from “-” to “waiting”. Further, the state information management unit 103 changes the state, which is associated with the identifier of the first monitoring target device M1 in the state information T2 stored in the second monitoring device W2, from “failure” to “normal”. After changing the state, the state information management unit 103 changes the waiting state for synchronization, which is associated with the identifier of the first monitoring target device M1 in the state information T2 stored in the second monitoring device W2, from “waiting” to “-”.

The information control unit 101 of the second monitoring device W2 transmits the state synchronization command of the first monitoring target device M1 including the state record (state “normal”) of an identifier (for example, “X0000”) of the first monitoring target device whose state has been changed, to other monitoring devices within the information processing system SYS.

As an example of the other monitoring device within the information processing system SYS, the first monitoring device W1 of FIG. 8 is illustrated. Upon receiving the state synchronization command, the information control unit 101 of the first monitoring device W1 sends the state synchronization command to the state information management unit 103. The state information management unit 103 receives the state synchronization command, and changes waiting state for synchronization, which is associated with the identifier of the first monitoring target device M1 in the state information T2 stored in the first monitoring device W1, from “-” to “waiting”. Further, the state information management unit 103 changes the state, which is associated with the identifier of the first monitoring target device M1 in the state information T2 stored in the first monitoring device W1, from “failure” to “normal” (synchronization of state information). After changing the state, the state information management unit 103 changes the waiting state for synchronization, which is associated with the identifier of the first monitoring target device M1 in the state information T2 stored in the first monitoring device W1, from “waiting” to “-”.

As described above, when state information of one monitoring device is updated, the updated state information is reflected on other monitoring devices in real time by the synchronization of state information. As a result, all monitoring devices may hold the state information of the same content.

(Synchronization and Assurance of Redundancy of Monitoring Devices)

Assume that in FIG. 8, one monitoring device (for example, first monitoring device W1) stores the event information of a monitoring target device (for example, first monitoring target device M1), and the other monitoring device (for example, second monitoring device W2) does not store the event information of the monitoring target device. In this case, the user is unable to access to the event information of the monitoring target device when the first monitoring device W1 is stopped due to a failure or periodical inspection. Accordingly, redundancy of the monitoring device (for example, event information) is assured by having the event information of the monitoring target device stored by multiple monitoring devices.

In particular, a large number of monitoring target devices in a large-scale information processing system SYS may operate applications for processing significant tasks 24 hours a day, every day. Therefore, redundancy of the monitoring device has to be assured for continuously monitoring such devices.

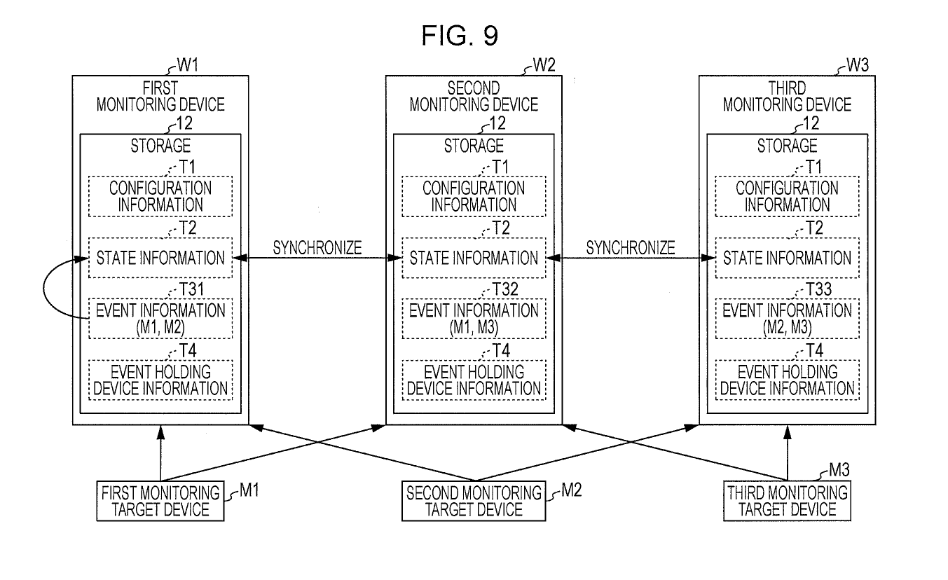

FIG. 9 is a schematic diagram illustrating processing of assuring the redundancy of monitoring devices, according to an embodiment. A first monitoring device W1 monitors a first monitoring target device M1 and a second monitoring device M2, a second monitoring device W2 monitors the first monitoring target device M1 and a third monitoring target device M3, and a third monitoring device W3 monitors the second monitoring target device M2 and the third monitoring target device M3. The first monitoring target device M1 and the second monitoring target device M2 notify event information to the first monitoring device W1. Then, the first monitoring target device M1 and the third monitoring target device M3 notify event information to the second monitoring device W2, and the second monitoring target device M2 and the third monitoring target device M3 notify event information to the third monitoring device W3.

The first monitoring device W1 has configuration information T1, state information T2, event holding device information T4, and event information T31. The second monitoring device W2 has configuration information T1, state information T2, event holding device information T4, and event information T32. The third monitoring device W3 has configuration information T1, state information T2, event holding device information T4, and event information T33.

The configuration information T1 is configuration information of the first monitoring target device M1 through the third monitoring target device M3. In the example of FIG. 4, the storage 12 of each of the first monitoring device W1, the second monitoring device W2, and the third monitoring device W3 stores configuration information of the first monitoring target device M1 through the third monitoring target device M3 in a table format.

The state information T2 is state information of the first monitoring target device M1 through the third monitoring target device M3. In the example of FIG. 5, the storage 12 of each of the first monitoring device W1, the second monitoring device W2, and the third monitoring device W3 stores state information of the first monitoring target device M1 through the third monitoring target device M3 in a table format.

The state information T2 includes state information records each of which associates, for example, an identifier of each of the first monitoring target device M1 through the third monitoring target device M3, and waiting state for synchronization of state information, in association with each other.

The event holding device information T4 is event holding device information of the first monitoring target device M1 through the third monitoring target device M3. In the example of FIG. 7, the storage 12 of each of the first monitoring device W1, the second monitoring device W2, and the third monitoring device W3 stores event holding device information of the first monitoring target device M1 through the third monitoring target device M3 in a table format.

The event holding device information record of the first monitoring target device M1 is, for example, a record which associates an identifier of the first monitoring target device M1, and an identifier of each of first and second monitoring devices W1 and W2 storing event information of the first monitoring target device M1 with each other. The event holding device information record of the second monitoring target device M2 is, for example, a record which associates an identifier of the second monitoring target device M2, and an identifier of each of first and third monitoring devices W1 and W3 storing event information of the second monitoring target device M2 with each other. The event holding device information record of the third monitoring target device M3 is, for example, a record which associates an identifier of the third monitoring target device M3, and an identifier of each of second and third monitoring devices W2 and W3 storing event information of the third monitoring target device M3 with each other.

The event holding device information T4 includes the above event holding device information records of the first monitoring target device M1, the second monitoring target device M2, and the third monitoring target device M3.

The event information T31 is information including event information of the first monitoring target device M1 and the second monitoring target device M2 (see event information (M1, M2)). The event information T32 is information including event information of the first monitoring target device M1 and the third monitoring target device M3 (see event information (M1, M3)). The event information T33 is information including event information of the second monitoring target device M2 and the third monitoring target device M3 (see event information (M2, M3)).

As described above, redundancy of the monitoring device is assured by storing event information of one monitoring target device (for example, first monitoring target device M1) in multiple monitoring devices (for example, first monitoring device W1 and second monitoring device W2).

According to the configuration of FIG. 9, even when the second monitoring device W2 is stopped due to a trouble, each of other monitoring devices is able to search for a monitoring device storing the same event information as that stored in the second monitoring device W2, based on the event holding device information stored in the each monitoring device, and able to refer to the same event information.

In addition to state information, event information may be synchronized. For example, assume a case where degree of importance of monitoring the second monitoring target device M2 is high. In the case, not only the first monitoring device W1 and the third monitoring device W3 but also the second monitoring device W2 stores state information and event information of the second monitoring target device M2. By storing as described above, even when the first monitoring device W1 and the third monitoring device W3 are stopped, the user is able to acquire state information and event information of the second monitoring target device M2 by using the second monitoring device W2. That is, redundancy of the monitoring device is enhanced.

In the case, before the second monitoring device W2 receives notification of event information from the second monitoring target device M2 and stores the event information, the first monitoring device W1 and the third monitoring device W3 have already stored event information (past event information) of the second monitoring target device M2. Accordingly, the second monitoring device W2 acquires event information from the first monitoring device W1 or the third monitoring device W3, the event information that has been stored by the first monitoring device W1 and the third monitoring device W3 before the second monitoring device W2 stores the event information of the second monitoring target device M2. This acquisition and storing of the event information is, for example, synchronization of event information.

Here, assume that state information and event information are synchronized among monitoring devices. Normally, information amount of state information stored in a monitoring device is smaller than event information stored therein. Accordingly, time duration for completing synchronization of state information between two monitoring devices (for example, between the first monitoring target device M1 and the second monitoring target device M2) is shorter than time duration for completing synchronization of event information therebetween. Further, the user tends to check event information of the monitoring target devices after having checked the state thereof.

Therefore, when synchronizing state information and event information between monitoring devices, state information is synchronized prior to event information.

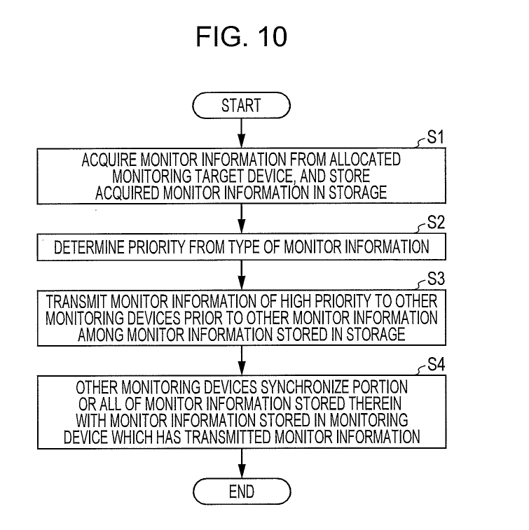

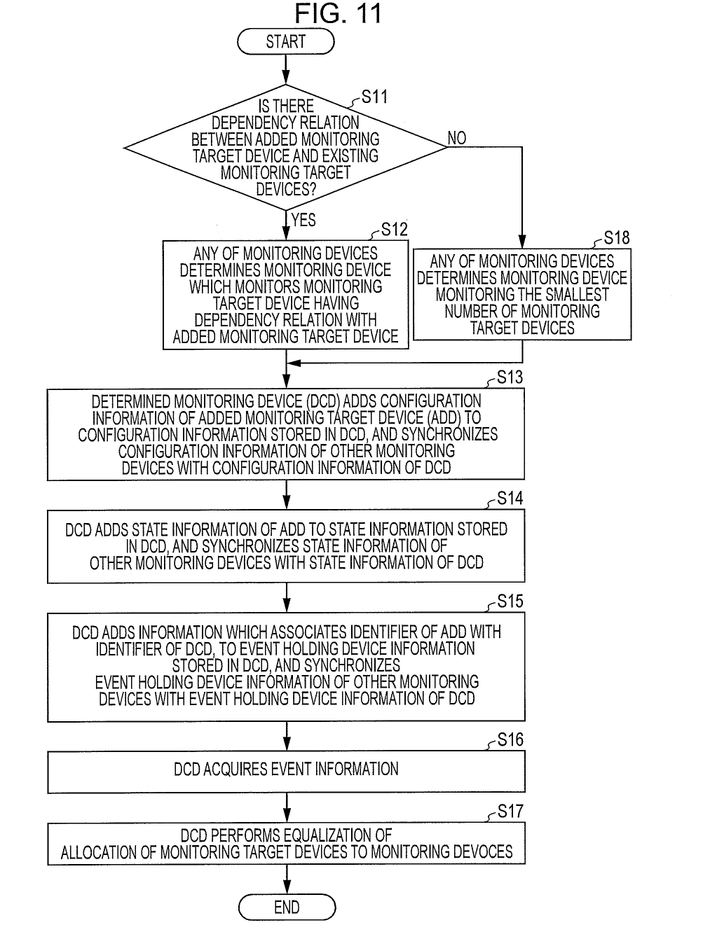

FIG. 10 is a diagram illustrating an example of flowchart for monitor information synchronization processing, according to an embodiment.

Operation S1: The event information management unit 105 of each of the first to m-th monitoring devices W1 to Wm acquires monitor information from allocated monitoring target devices and stores the acquired monitor information in the storage 12. The monitor information is information including, for example, event information.

Operation S2: The information control unit 101 of each of the first to m-th monitoring devices W1 to Wm determines the priority in transmitting monitor information from the type of the monitor information.

Operation S3: The synchronization control unit 106 of each of the first to m-th monitoring devices W1 to Wm transmits monitor information of high priority prior to other monitor information among monitor information stored in the storage 12, to other monitoring devices. In other words, when transmitting monitor information stored in the storage 12 to other monitoring devices, the synchronization control unit 106 of each of the first to m-th monitoring devices W1 to Wm controls such that monitor information of high priority (for example, monitor information with high priority) identified (or determined) based on the type of the monitor information is transmitted prior to other monitor information.

Operation S4: The information control unit 101 of each of other monitoring devices stores transmitted monitor information in the storage 12 thereof. Then, the synchronization control unit 106 of each of other monitoring devices synchronizes a portion or whole of monitor information stored in the each other monitoring device with the monitor information stored in a monitoring device which has transmitted the monitor information.

Here, the monitor information includes state information indicating state of each of multiple monitoring target devices (see FIG. 5), and event information indicating an event which has occurred in the monitoring target devices (see FIG. 6). The synchronization control unit 106 controls transmission of the monitor information so that the state information is transmitted to other monitoring devices prior to the event information.

Further, event information contains the type of the event (for example, error, warning, and information) which has occurred in a device. The synchronization control unit 106 of each of the first to m-th monitoring devices W1 to Wm discriminates, based on the event type, between first event information to be transmitted with first priority and second event information to be transmitted with the second priority lower than the first priority. The synchronization control unit 106 of each of the first to m-th monitoring devices W1 to Wm controls transmission of the event information so that the first event information is transmitted to other monitoring devices prior to the second event information.

Specific processing for transmission and synchronization of state information and event information is described in detail in FIG. 11 and thereafter.

According to this embodiment, since an integrated monitoring device for integrally managing monitoring devices is not required, system configuration is not complicated. In a case where the integrated monitoring device stores all monitor information acquired by all monitoring devices under the control thereof, the user is able to acquire monitor information of an information processing device in which an error has occurred, by operating the integrated monitoring device. However, when vast amount of monitor information acquired by all monitoring devices are stored, a limited storage resource provided in the integrated monitoring device is compressed. Therefore, it is not realistic that the integrated monitoring device stores all monitor information acquired by all monitoring devices.

On the other hand, when information acquired from an information processing device of the monitoring target is stored in multiple monitoring devices in a distributed manner to enable any monitoring device to refer to the monitor information of the information processing device, the monitor information has to be synchronized by each of the monitoring devices in real time. However, as the amount of monitor information becomes large, load of monitor information synchronization processing increases and thereby synchronization delay of monitor information occurs, reducing monitoring efficiency.

However, according to this embodiment, transmission of information to be displayed for a user in real time (for example, state information) has priority over transmission of information to be displayed for a user when a specific operation is performed by the user for trouble investigation (for example, event information). That is, state information is synchronized in real time among monitoring devices. Accordingly, the user is able to read state information that is accessed with high frequency, in the latest state. Consequently, effects due to synchronization delay of the monitor information may be reduced, and thereby degradation of the monitoring efficiency may be suppressed.

According to this embodiment, when a trouble occurs in a device, the user is able to read event information of the device in which a trouble has occurred, without having information on which monitoring device monitors which device (monitor configuration information). Especially, when troubles occur in multiple monitoring target devices, the user is able to read event information of the multiple monitoring target devices and investigate cause of the troubles without the monitor configuration information.

### Second Embodiment

### Processing for Adding Monitoring Target Device

Consider that the user adds a monitoring target device to the information processing system SYS. The monitoring target device to be added is, for example, a virtual machine or physical machine. When a monitoring target device is added to the information processing system SYS, existing monitoring devices in the information processing system SYS monitor the monitoring target device. At that time, all monitoring devices in the information processing system SYS store configuration information, state information, and event holding device information for the added monitoring target device. Further, a monitoring device monitoring the added monitoring target device stores event information notified from the added monitoring target device.

Here, when a monitoring target device is added, a monitoring device which monitors the added monitoring target device is determined out of all monitoring devices, based on event holding device information. The monitoring target device notifies event information to the determined monitoring device. The monitoring device is determined mainly based on the three points described below.

A first point is that to equalize the processing load of each monitoring device in the information processing system SYS, the number of monitoring target devices monitored by each of monitoring devices is equalized. For example, assume that in the information processing system SYS, the number of monitoring target devices monitored by the first monitoring device W1 is N1 (N1 is an integer), the number of monitoring target devices monitored by the second monitoring device W2 is N2 (N2 is an integer smaller than N1), and the number of monitoring target devices monitored by the third monitoring device W3 is N3 (N3 is an integer smaller than N2). Then, assume that one monitoring target device is added to the information processing system SYS. In this assumption, the third monitoring device W3 monitors this one monitoring target device since the monitoring device W3 monitors a smallest number of monitoring targets. In other words, the third monitoring device W3 becomes one of monitoring devices which store event information on the added one monitoring target device.

A second point is that the redundancy of monitoring devices is assured. In other words, at least two monitoring devices store event information for the newly added monitoring target device.

A third point is that when a newly added monitoring target device has a dependency relationship with an existing monitoring target device, a monitoring device monitoring the existing monitoring target device monitors the newly added monitoring target device. That is, a monitoring device monitoring the existing monitoring target device stores event information of both the existing monitoring target device and the newly added monitoring target device.

The dependency relationship is described in detail with reference to FIG. 4. The third point is determined by considering the efficiency in trouble investigation by the user.

For example, assume that the newly added fourth monitoring target device M4 is a virtual machine, and the first monitoring target device M1 is a physical server activating the virtual machine. There is a dependency relationship between the first monitoring target device M1 and the fourth monitoring target device M4, where a dependency destination monitoring target device is the first monitoring target device M1 (physical server), and a dependency source monitoring target device is the fourth monitoring target device M4 (virtual machine).

When the fourth monitoring target device M4 is stopped due to occurrence of a failure, cause of the failure may lie in the first monitoring target device M1 (physical server) at the dependency destination. If a same monitoring device monitors the dependency source monitoring target device and the dependency destination monitoring target device, the user may collectively acquire event information of both the dependency source monitoring target device and the dependency destination monitoring target device by accessing the same monitoring device. As a result, efficiency in trouble investigation may be improved.

(Operational Flowchart and Operational Sequence for Processing of Adding a Monitoring Target Device)

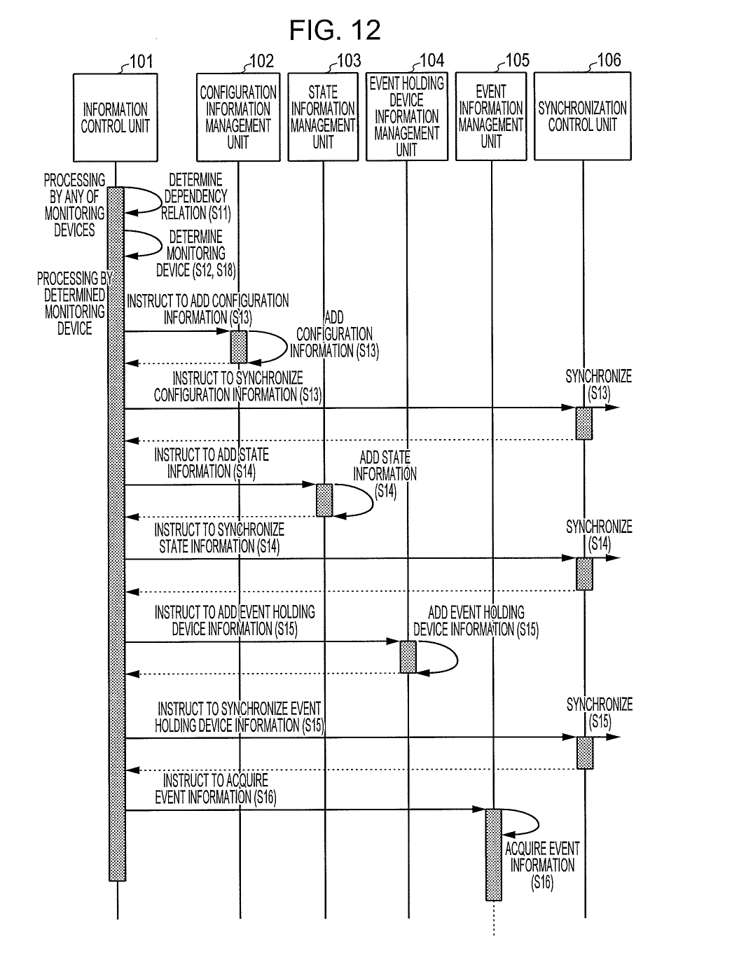

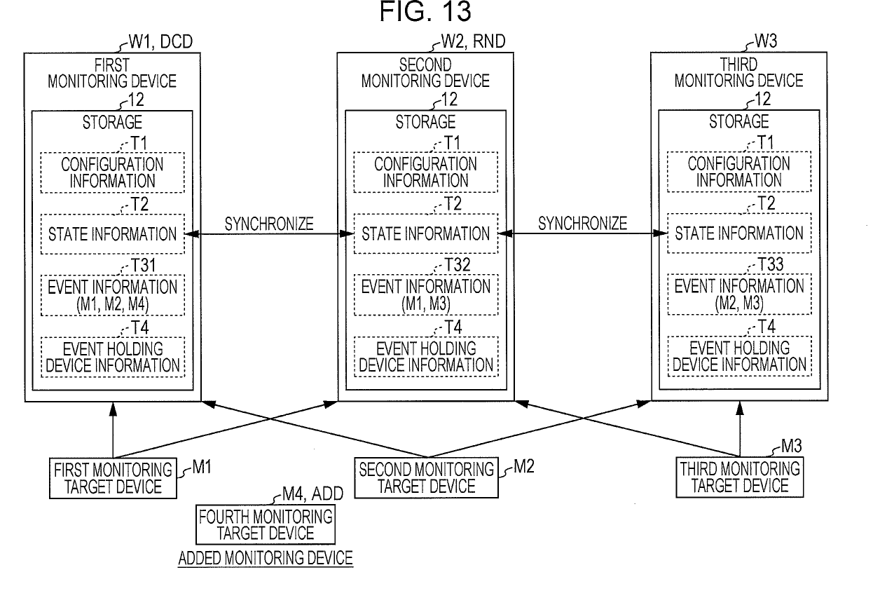

FIG. 11 is a diagram illustrating an example of an operational flowchart for processing of adding a monitoring target device, according to an embodiment. FIG. 12 is a diagram illustrating an example of an operational sequence for processing of adding a monitoring target device, according to an embodiment.

Operation S11: The information control unit 101 of any of monitoring devices (hereafter also abbreviated as the monitoring device RND) in the information processing system SYS determines whether there is a dependency relationship between the newly added monitoring target device (hereafter also abbreviated as the monitoring target device ADD) and an existing monitoring target device in the information processing system SYS. The monitoring device RND is, for example, the second monitoring device W2, and the monitoring target device ADD is, for example, the fourth monitoring target device M4.

When there is a dependency relationship (S11: YES), the process proceeds to the operation S12.

Operation S12: The information control unit 101 of the monitoring device RND determines a monitoring device which monitors a monitoring target device having a dependency relationship with the monitoring target device ADD. Thereafter, a monitoring device determined at the operation S12 stores event information of the monitoring target device ADD.

Operation S13: The information control unit 101 of the monitoring device determined at the operation S12 (hereinafter also abbreviated as monitoring device DCD) instructs the configuration information management unit 102 to add configuration information. In response to the addition instruction, the configuration information management unit 102 updates configuration information of the monitoring device DCD by adding configuration information of the monitoring target device ADD to the configuration information stored in the monitoring device DCD. The information control unit 101 instructs the synchronization control unit 106 to synchronize the updated configuration information. In response to the synchronization instruction, the synchronization control unit 106 synchronize (or reflects) configuration information stored in other monitoring devices with the updated configuration information of the monitoring device DCD.

Operation S14: The information control unit 101 of the monitoring device DCD instructs the state information management unit 103 to add event information. In response to the addition instruction, the state information management unit 103 updates state information of the monitoring device DCD by adding state information of the monitoring target device ADD to the state information stored in the monitoring device DCD. The information control unit 101 instructs the synchronization control unit 106 to synchronize the updated state information. In response to the synchronization instruction, the synchronization control unit 106 synchronizes state information stored in other monitoring devices with the updated state information of the monitoring device DCD.

Operation S15: The information control unit 101 of the monitoring device DCD instructs the event holding device information management unit 104 to add event holding device information. In response to the addition instruction, the event holding device information management unit 104 updates event holding device information of the monitoring device DCD by adding information which associates an identifier of the monitoring target device ADD and an identifier of the monitoring device DCD with each other, to the event holding device information stored in the monitoring device DCD. The information control unit 101 instructs the synchronization control unit 106 to synchronize the updated state information. In response to the synchronization instruction, the synchronization control unit 106 synchronizes event holding device information stored by other monitoring devices with the updated event holding device information of the monitoring device DCD.

Operation S16: The information control unit 101 of the monitoring device DCD instructs the event information management unit 105 to acquire event information of the monitoring target device ADD. In response to the acquisition instruction, the event information management unit 105 acquires event information of the monitoring target device ADD. In this case, the information control unit 101 of the monitoring device DCD transmits, to the monitoring target device ADD, a command for instructing the monitoring target device ADD to transmit event information to the monitoring device DCD. This command includes an identifier (for example, IP address) which uniquely identifies the monitoring device DCD in a network. In response to this command, the monitoring target device ADD transmits event information to the monitoring device DCD.

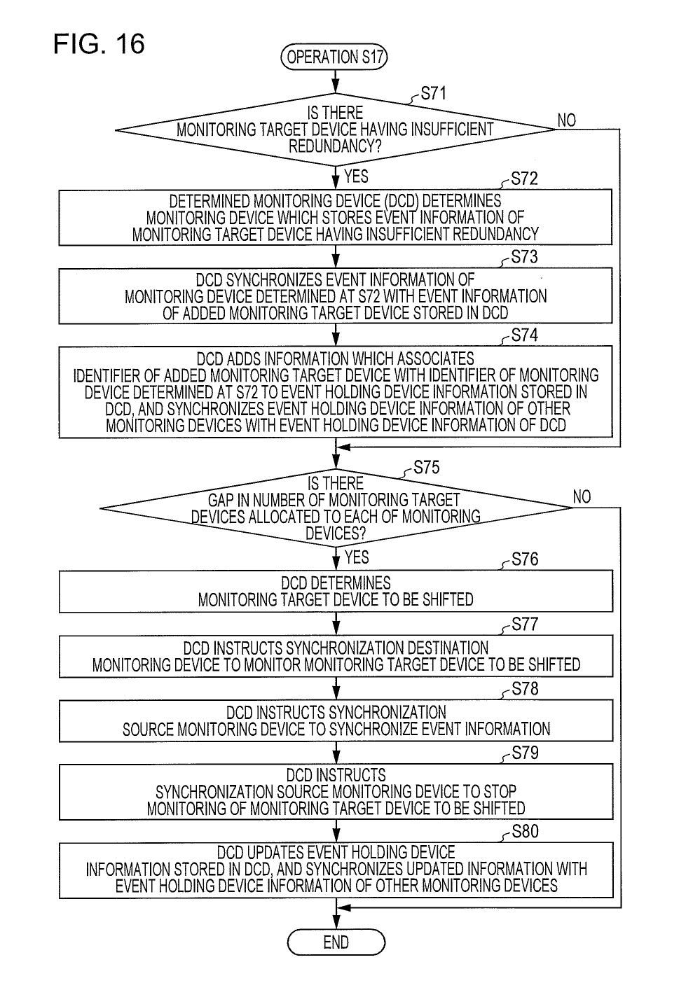

Operation S17: The information control unit 101 of the monitoring device DCD performs equalization of allocation of monitoring target devices to monitoring devices. Detail of S17 will be described with reference to FIG. 16.

When it is determined that there is no dependency relation at the operation S11 (S11: No), the process proceeds to the operation S18.

Operation S18: The information control unit 101 of the monitoring device RND determines a monitoring device monitoring a smallest number of monitoring target devices, based on event holding device information stored in the monitoring device RND. A monitoring device determined at the operation S18 becomes the monitoring device DCD.

(Specific Example of Addition Processing of Monitoring Target Device)

FIG. 13 is a schematic diagram illustrating a process of adding a monitoring target device, according to an embodiment. FIF. 13 illustrates an example in which a fourth monitoring target device M4 is added to the information processing system STS in FIG. 9. The user operates the client terminal C1 to access to any of monitoring devices (monitoring device RND) in the information processing system SYS. The monitoring device RND is, for example, the second monitoring device W2. The monitoring target device ADD is the fourth monitoring target device M4 of FIG. 13.

Operation S11 of FIG. 11 is described specifically. The user operates the client terminal C1 to transmit an addition instruction command including attributes of the monitoring target device ADD to the information control unit 101 via the terminal interface unit 107 of the second monitoring device W2. Here, when the fourth monitoring target device M4 has a dependency relationship, the user includes an identification symbol (for example, an identifier or a host name) for identifying a dependency destination monitoring target device in the addition instruction command.

When the addition instruction command contains an identification symbol for identifying the dependency destination monitoring target device, the information control unit 101 of the second monitoring device W2 determines whether the identification symbol of the dependency destination monitoring target device is contained in the dependency relationship (for example, see FIG. 4) of a monitoring target device in the configuration information T1 stored in the second monitoring device W2 (S11). In the case, when the identification symbol for identifying the monitoring dependency destination target device is “host-c”, “host-c” is contained in the dependency destination field of the configuration information T1 of FIG. 4. Therefore, the information control unit 101 determines “YES” at S11, and the process moves to operation S12.

Next, operation S12 is described specifically. The information control unit 101 of the second monitoring device W2 identifies an identifier of the dependency destination monitoring target device. In the above example, the information control unit 101 identifies, based on the configuration information T1, the identifier “X0001” of the monitoring target device associated with the host name “host-c” of the dependency destination monitoring target device.

The information control unit 101 of the second monitoring device W2 identifies, based on the event holding device information T4 (for example, see FIG. 7) stored in the second monitoring device W2, a first monitoring device W1 which monitors a monitoring target device (monitoring target device having a dependency relationship with the fourth monitoring target device M4) identified with the identified identifier “X0001”. That is, the information control unit 101 of the second monitoring device W2 determines a monitoring device identified by a monitoring target device identifier “W1” stored in a line including the identifier “X0001” of the even holding device information T4. The monitoring device thus determined becomes a monitoring device DCD, which is the first monitoring device W1 in the example of FIG. 7.

The information control unit 101 of the monitoring device RND transmits an addition instruction command containing attributes of the monitoring target device ADD to the information control unit 101 of the monitoring device DCD. When the monitoring device RND is identical to the monitoring device DCD, this transmission of the addition instruction command is not performed. Next, the process moves to operation S13.

Next, operation S13 is described specifically. The information control unit 101 of the first monitoring device W1 serving as the monitoring device DCD transmits the addition instruction command to the configuration information management unit 102.

Upon receiving the addition instruction command, the configuration information management unit 102 of the first monitoring device W1 adds attributes of the monitoring target device contained in the addition instruction command to the configuration information T1 stored in the first monitoring device W1. When the host name of the dependency destination monitoring target device is contained in the addition instruction command, the configuration information management unit 102 adds the dependency destination host name and the dependency source host name (monitoring target device ADD) to the configuration information T1 stored in the first monitoring device W1.

Here, assume that the identifier of the added fourth monitoring target device M4 (monitoring target device ADD) is “X0004”. This identifier is contained in the addition instruction command.

When starting the above addition processing, the configuration information management unit 102 changes a waiting state for synchronization of configuration information associated with the identifier “X0004” of the configuration information T1 from “-” to “waiting”. Upon completing the above addition processing, the configuration information management unit 102 changes the waiting state from “waiting” to “-”.

After changing the waiting state for synchronization in the configuration information from “-” to “waiting”, the synchronization control unit 106 of the first monitoring device W1 performs the following processing. That is, the synchronization control unit 106 synchronizes configuration information stored in monitoring devices identified by identifiers of monitoring devices (hereafter referred to as other monitoring devices) other than the first monitoring device W1, with the updated configuration information T1. In other words, the synchronization control unit 106 of the first monitoring device W1 reflects the updated configuration information T1 on configuration information stored in the other monitoring devices.

For example, assume that the other monitoring devices are the second monitoring device W2 and the third monitoring device W3. The synchronization control unit 106 of the first monitoring device W1 transmits a synchronization instruction command including the updated configuration information T1 to the information control unit 101 of each of the second monitoring device W2 and the third monitoring device W3.

Upon receiving the synchronization instruction command, the information control unit 101 of the second monitoring device W2 transfers the synchronization instruction command including the updated configuration information T1 to the configuration information management unit 102. Upon receiving the synchronization instruction command, the configuration information management unit 102 of the second monitoring device W2 overwrites the updated configuration information T1 contained in the synchronization instruction command to the configuration information T1 stored in the second monitoring device W2. With this overwriting, the other monitoring devices store same configuration information as the updated configuration information T1. In a manner similar to the second monitoring device W2, the third monitoring device W3 overwrites the updated configuration information T1 contained in the synchronization instruction command to the configuration information T1 stored in the third monitoring device W3.

The synchronization control unit 106 of the first monitoring device W1 may transmit a synchronization instruction command containing a configuration information record of the added fourth monitoring target device M4, to the second monitoring device W2 and the third monitoring device W3. The configuration information management unit 102 of each of the second monitoring device W2 and the third monitoring device W3 adds the configuration information record of the fourth monitoring target device M4 to the configuration information T1 stored in the each monitoring device (synchronization of configuration information).

Next, operation S14 is described specifically. The information control unit 101 of the first monitoring device W1 serving as the monitoring device DCD transmits an addition instruction command to the state information management unit 103.

Upon receiving the addition instruction command, the state information management unit 103 of the first monitoring device W1 adds the identifier “X0004” identifying the monitoring target device and the state “default”, which are contained in the received addition instruction command, to state information T2 stored in the first monitoring device W1.

When starting the above addition processing, the state information management unit 103 of the first monitoring device W1 changes, in the state information T2, a waiting state for synchronization of state information, which is associated with the identifier “X0004” of the monitoring target device, from “-” to “waiting”. Then, upon completion of the above addition processing, the state information management unit 103 changes the waiting state from “waiting” to “-”.

After changing the waiting state for synchronization of state information from “-” to “waiting”, the synchronization control unit 106 of the first monitoring device W1 performs the following processing. That is, the synchronization control unit 106 synchronizes state information stored in the other monitoring devices with the updated event information T2. In other words, the synchronization control unit 106 of the first monitoring device W1 reflects the updated state information T2 on state information stored in the other monitoring devices.

For example, assume that the other monitoring devices are the second monitoring device W2 and the third monitoring device W3. The synchronization control unit 106 of the first monitoring device W1 transmits a synchronization instruction command including the updated configuration information T1 to the information control unit 101 of each of the second monitoring device W2 and the third monitoring device W3.

Upon receiving the synchronization instruction command, the information control unit 101 of the second monitoring device W2 transfers the synchronization instruction command including the updated state information T2 to the state information management unit 103. Upon receiving the synchronization instruction command, the state information management unit 103 of the second monitoring device W2 overwrites the updated state information T2 contained in the synchronization instruction command to the state information T2 stored in the second monitoring device W2. With this overwriting, the second monitoring device W2 stores the same state information as the updated state information T2. In a manner similar to the second monitoring device W2, the third monitoring device W3 overwrites the updated state information T2 contained in the synchronization instruction command to the state information T2 stored in the third monitoring device W3.

The synchronization control unit 106 of the first monitoring device W1 may transmit a synchronization instruction command containing an added state information record of the fourth monitoring target device M4 to the second monitoring device W2 and the third monitoring device W3. The state information management unit 103 of each of the second monitoring device W2 and the third monitoring device W3 adds the added state information record to the state information T2 stored in the each monitoring device.

Next, operation S15 is described specifically. The information control unit 101 of the first monitoring device W1 serving as the monitoring device DCD transmits the addition instruction command to the event holding device information management unit 104.

Upon receiving the addition instruction command, the event holding device information management unit 104 of the first monitoring device W1 adds information which associates the identifier “X0004” of a monitoring target device contained in the addition instruction command and the identifier “W1” of the first monitoring device W1 with each other, to the event holding device information T4 stored in the first monitoring device W1.

Next, the synchronization control unit 106 of the first monitoring device W1 synchronizes event information stored in other monitoring devices with the updated event holding device information T4. In other words, the synchronization control unit 106 of the first monitoring device W1 reflects the updated event holding device information T4 on event holding device information stored in the other monitoring devices.

For example, assume that the other monitoring devices are the second monitoring device W2 and the third monitoring device W3. The synchronization control unit 106 of the first monitoring device W1 transmits a synchronization instruction command including the updated event holding device information T4 to the information control unit 101 of each of the second monitoring device W2 and the third monitoring device W3.

Upon receiving the synchronization instruction command, the information control unit 101 of the second monitoring device W2 transfers the synchronization instruction command including the updated event holding device information T4 to the event holding device information management unit 104. Upon receiving the synchronization instruction command, the event handling device information management unit 104 of the second monitoring device W2 overwrites the updated event holding device information T4 contained in the synchronization instruction command to the event holding device information T4 stored in the second monitoring device W2. With this overwriting, the other monitoring devices store the same event holding device information as the updated event holding device information T4. In a manner similar to the second monitoring device W2, the third monitoring device W3 overwrites the updated event holding device information T4 contained in the synchronization instruction command to the event holding device information T4 stored in the third monitoring device W3.

The synchronization control unit 106 of the first monitoring device W1 may transmit a synchronization instruction command containing an added event holding device information record of the fourth monitoring target device M4 to the second monitoring device W2 and the third monitoring device W3. The event holding device information record of the added fourth monitoring target device M4 is information which associates the identifier “X0004” of the fourth monitoring target device M4 and the identifier “W1” of the first monitoring device W1 with each other. The event holding device information management unit 104 of each of the second monitoring device W2 and the third monitoring device W3 adds the added event holding device information record to the event holding device information T4 stored in the each monitoring device.

Then, the event information management unit 105 of the first monitoring device W1 (monitoring device DCD) instructs the fourth monitoring target device M4 (monitoring target device ADD) to notify event information to the first monitoring device W1. Then, in response to the instruction, the event information management unit 105 acquires the event information notified by the fourth monitoring target device M4, and stores the acquired event information as the event information T31 (see event information (M1, M2, M4)).

Next, operation S18 is described specifically.

When an identification symbol for identifying a dependency destination monitoring target device is not contained in the addition instruction command (S11: No), the information control unit 101 of the second monitoring device W2 via which the user's operation is performed moves the processing thereof to S18. Alternatively, when an identification symbol of a dependency destination monitoring target device is not contained in the dependency relationship of monitoring target devices in the configuration information T1 stored in the second monitoring device W2 (S11: No), the information control unit 101 of the second monitoring device W2 moves the processing thereof to S18.

The information control unit 101 of the second monitoring device W2 determines a monitoring device monitoring a smallest number of monitoring target devices, based on the event holding device information T4 stored in the second monitoring device W2. When there are multiple monitoring devices monitoring a smallest number of monitoring target devices, the information control unit 101 of the second monitoring device W2 determines any one of the multiple monitoring devices. A monitoring device determined by the information control unit 101 of the second monitoring device W2 becomes the monitoring device DCD.

For example, assume that the event holding device information T4 includes the following three types of information. Information of the first type is information associating the identifier of the first monitoring device W1 and the identifier of each of the first monitoring target device M1 and the second monitoring target device M2 with each other. Information of the second type is information associating the identifier of the second monitoring device W2 and the identifier of each of the first monitoring target device M1 and the third monitoring target device M3 with each other. Information of the third type is information associating the identifier of the third monitoring device W3 and the identifier of each of the second monitoring target device M2 and the third monitoring target device M3 with each other.

In this assumption, since there are three monitoring devices monitoring a smallest number of monitoring target devices (first monitoring device W1, second monitoring device W2, and third monitoring device W3), the information control unit 101 of the second monitoring device W2 determines, for example, the second monitoring device W2 (S18). Upon completing operation S18, the process proceeds to the operation S13 described above.

As illustrated in FIG. 13, even when system configuration of monitoring target devices is changed due to addition of a monitoring target device, monitoring target devices are automatically monitored by at least one of monitoring devices in the information processing system. This eliminates the need for user's operation, resulting in reducing user's work load while improving the monitoring precision.

(Processing for Deleting a Monitoring Target Device)

Assume that a monitoring target device is deleted from the information processing system SYS. For example, in a case where the monitoring target device is a virtual machine, when operation of the virtual machine ends, the information processing system SYS deletes the virtual machine from the monitoring target devices to be monitored. Also, in a case where the monitoring target device is a physical machine, when the physical machine is scrapped due to elapse of the service life thereof, the information processing system SYS deletes the physical machine from the monitoring target devices to be monitored.

(Operational Flowchart and Sequence for Deleting a Monitoring Target Device)

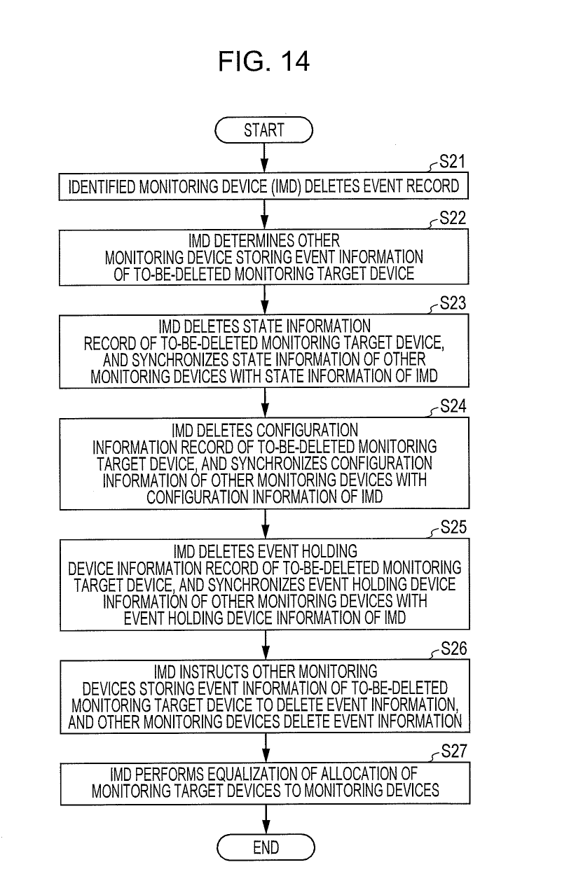

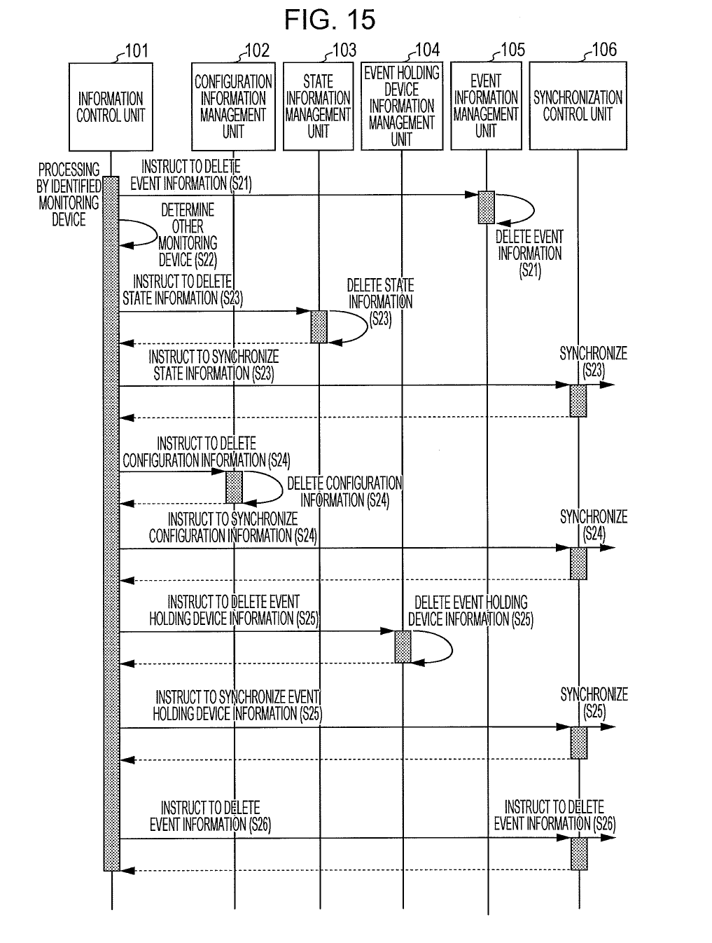

FIG. 14 is a diagram illustrating an example of an operational flowchart for deleting a monitoring target device, according to an embodiment. FIG. 15 is a diagram illustrating an example of an operational sequence for deleting a monitoring target device, according to an embodiment. In the illustration of FIG. 14, assume that the processing below has been performed in advance. That is, the user operates the client terminal C1 to access to any of monitoring devices (monitoring device RND) in the information processing system SYS.

The user operates the client terminal C1 to transmit a deletion instruction command including an identification symbol for uniquely identifying a to-be-deleted monitoring target device, to the information control unit 101 via the terminal interface unit 107 of the monitoring device RND. Based on the event holding device information stored in the monitoring device RND, the information control unit 101 of the monitoring device RND identifies one of monitoring devices which stores the event information of the to-be-deleted monitoring target device.

To assure the redundancy, two or more monitoring devices store event information of the same monitoring target device. Therefore, the information control unit 101 of the monitoring device RND identifies one of the two or more monitoring devices storing the event information of the same monitoring target device.

The information control unit 101 of the monitoring device RND transmits a deletion instruction command containing the identifier of a to-be-deleted monitoring target device, to the identified monitoring device (hereafter referred to as the identified monitoring device).

Operation S21: The information control unit 101 of the identified monitoring device receives the deletion instruction command, and instructs the event information management unit 105 to delete an event information record of the to-be-deleted monitoring target device. The event information management unit 105 deletes event information record having the identifier of the monitoring target device contained in the deletion instruction command out of the event information stored in the identified monitoring device.

Operation S22: Based on the event holding device information T4 stored in the identified monitoring device, the information control unit 101 of the identified monitoring device determines other monitoring devices which store event information of the to-be-deleted monitoring target device.

Operation S23: The information control unit 101 of the identified monitoring device instructs the state information management unit 103 to delete state information of the to-be-deleted monitoring target device. In response to this instruction, the state information management unit 103 updates state information of the identified monitoring device by deleting a state information record having an identifier of the to-be-deleted monitoring target device, from the state information stored in the identified monitoring device.

The information control unit 101 instructs the synchronization control unit 106 to synchronize state information. In response to the synchronization instruction, the synchronization control unit 106 synchronize (or reflects) state information stored in other monitoring devices with the updated state information. The other monitoring devices are monitoring devices identified by monitoring device identifiers other than an identifier of the identified monitoring device, which are contained in the event holding device information T4.

Specifically, the information control unit 101 transmits the deletion instruction command for state information, which includes the identifier of the to-be-deleted monitoring target device, to the other monitoring devices. Here, when there are multiple other monitoring devices, the information control unit 101 transmits the deletion instruction command for the state information, to each of the multiple other monitoring devices.

Upon receiving the deletion instruction command for the state information, the information control unit 101 of each of the other monitoring devices sends the deletion instruction command to the configuration information management unit 102. The configuration information management unit 102 of each of the other monitoring devices deletes a state information record having an identifier of the to-be-deleted monitoring target device, from the state information stored in the each monitoring device.

Operation S24: The information control unit 101 of the identified monitoring device instructs the configuration information management unit 102 to delete configuration information of the to-be-deleted monitoring target device. In response to the instruction, the configuration information management unit 102 updates the configuration information of the identified monitoring device by deleting a configuration information record having an identifier of the to-be-deleted monitoring target device, from the configuration information stored in the identified monitoring device.

The information control unit 101 instructs the synchronization control unit 106 to synchronize configuration information. In response to the synchronization instruction, the synchronization control unit 106 synchronizes (or reflects) configuration information stored in other monitoring devices with the updated configuration information.

Specifically, the information control unit 101 transmits the deletion instruction command for the configuration information, which includes the identifier of the to-be-deleted monitoring target device, to other monitoring devices. Here, when there are multiple other monitoring devices, the information control unit 101 transmits the deletion instruction command for the configuration information to each of the multiple other monitoring devices.

Upon receiving the deletion instruction command, the information control unit 101 of each of the other monitoring devices transfers the deletion instruction command to the configuration information management unit 102. The configuration information management unit 102 updates the configuration information of the identified monitoring device, by deleting a configuration information record having an identifier of the to-be-deleted monitoring target device, from the configuration information stored in the identified monitoring device.

Operation S25: The information control unit 101 of the identified monitoring device instructs the event holding device information management unit 104 to delete event holding device information of the to-be-deleted monitoring target device. In response to this instruction, the event holding device information management unit 104 update the event holding device information of the identified monitoring device, by deleting an event holding device information record having the identifier of the to-be-deleted monitoring target device, from the event holding device information stored in the identified monitoring device.

The information control unit 101 instructs the synchronization control unit 106 to synchronize the event holding device information. In response to the synchronization instruction, the synchronization control unit 106 synchronizes (or reflects) event holding device information stored in other monitoring devices with the updated event holding device information.

Specifically, the information control unit 101 transmits the deletion instruction command for the event holding device information, which includes the identifier of the to-be-deleted monitoring target device, to the other monitoring devices. Here, when there are multiple other monitoring devices, the information control unit 101 transmits the deletion instruction command for the event holding device information, to each of the multiple other monitoring devices.

Upon receiving the deletion instruction command, the information control unit 101 of each of the other monitoring devices transfers the deletion instruction command to the event holding device information management unit 104. The event holding device information management unit 104 deletes the event holding device information record having an identifier of the to-be-deleted monitoring target device, from the event holding device information stored in the each monitoring device.

Operation S26: The information control unit 101 of the identified monitoring device provides a deletion instruction to the synchronization control unit 106. The deletion instruction is an instruction to transmit a deletion instruction command for the event information, to other monitoring devices storing event information for a to-be-deleted monitoring target device.

In response to this instruction, the synchronization control unit 106 transmits a deletion instruction command including the identification symbol of the to-be-deleted monitoring target device, to the other monitoring devices. The information control unit 101 of each of the other monitoring devices transfers the deletion instruction command to the event information management unit 105. The event information management unit 105 of each of the other monitoring devices deletes event information containing the identification symbol, from the event information stored in the each monitoring device. When there are multiple other monitoring devices, the synchronization control unit 106 transmits the deletion instruction command to each of the multiple other monitoring devices.

Since processing of operation S27 is the same as the operation S17, description of the operation S27 is omitted here.

According to the processing illustrated in FIG. 14 and FIG. 15, up-to-date configuration information, state information, and event holding device information corresponding to deletion of a monitoring target device is shared and stored among monitoring devices. Further, event information of the to-be-deleted monitoring target device may also be deleted. With this deletion of the information, storage capacity of monitoring devices may be increased.

(Equalization of Monitoring Devices)

When a monitoring target device is added, to assure the redundancy of monitoring devices, multiple monitoring devices are required to store event information of the monitoring target device. For example, when event information of the added monitoring target device is maintained by two monitoring devices (maintained in duplication), the two monitoring devices store event information of the added monitoring target device.

A same monitoring device monitors monitoring target devices having a dependency relationship with each other (see S12 of FIG. 11). Due to processing at the operation S12, a difference (un-equalized state) in the number of monitoring target devices allocated to each monitoring device occurs among monitoring devices. Further, due to deletion of a monitoring target device, a difference in the number of monitoring target devices allocated to each monitoring device occurs.

Normally, when the number of monitoring target devices allocated to each monitoring device is equal among monitoring devices, increase of monitoring load in a specific monitoring device may be suppressed. Accordingly, monitoring devices are configured to equalize the number of monitoring target devices monitored allocated to each monitoring device (hereafter refereed to the monitoring device equalization) while assuring the redundancy of the monitoring devices.

FIG. 16 is a diagram illustrating an example of an operational flowchart for equalizing allocation of monitoring target devices to monitoring devices, according to an embodiment. Operations of FIG. 16 may be performed, for example, in operation S17 of FIG. 11 and in operation S27 of FIG. 14. In the monitoring target equalization processing after addition of a monitoring target device (see FIG. 11), the monitoring device DCD described below represents a monitoring device which stores event information of the added monitoring target device ADD determined at operations S12 and S18 of FIG. 11.

In the monitoring target equalization processing after deletion of a monitoring target device (see FIG. 14), the monitoring device DCD described below represents a monitoring device (identified monitoring device illustrated in FIG. 14) which stores event information of the deleted monitoring target device.

Operation S71: The information control unit 101 of the monitoring device DCD determines, based on event holding device information stored in the monitoring device DCD, whether there is a monitoring target device having insufficient redundancy. For example, assume that event information is stored in N-fold duplication to assure the redundancy in the information processing system SYS. That is, assume that N monitoring devices monitor one monitoring target device in a distributed manner. In this assumption, when (N−1) or less monitoring devices monitor the one monitoring target device described above, the information control unit 101 of the monitoring device DCD determines that there is a monitoring target device having insufficient redundancy.

As illustrated in FIG. 7, event holding device information is information which associates an identifier of a monitoring device and an identifier of a monitoring target device monitored by the monitoring device with each other. Therefore, the information control unit 101 of the monitoring device DCD is able to determine the number of monitoring target devices to be monitored by the monitoring device DCD by referring to event holding device information stored in the monitoring device DCD.

When there is a monitoring target device having insufficient redundancy (S71: YES), the process proceeds to S72. When there is no monitoring target device having insufficient redundancy (S71: NO), the process proceeds to S75.

Operation S72: The information control unit 101 of the monitoring device DCD determines, based on event holding device information stored in the monitoring device DCD, a monitoring device to store event information of a monitoring target device having insufficient redundancy, from among monitoring devices other than monitoring devices already storing event information of the monitoring target device having insufficient redundancy.

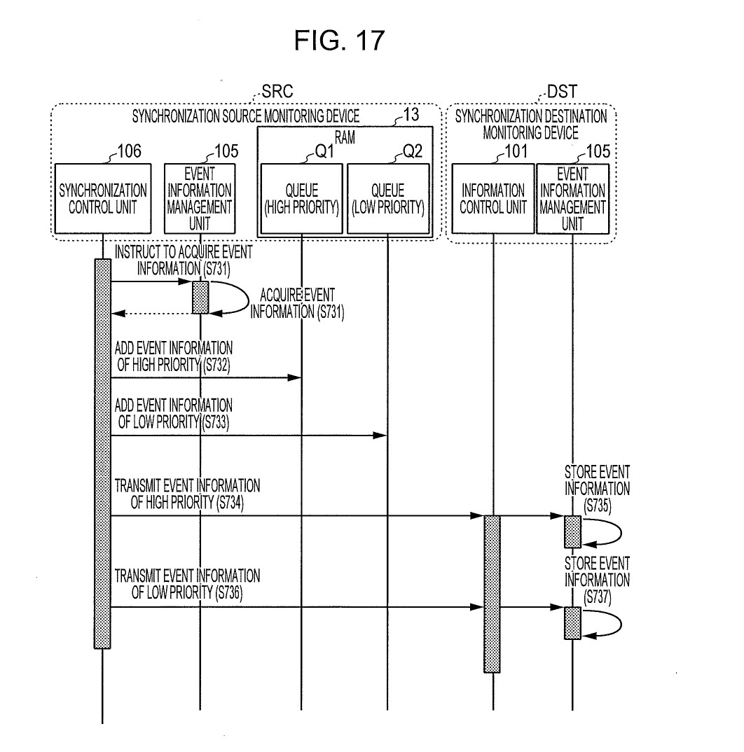

Operation S73: The information control unit 101 of the monitoring device DCD instructs the synchronization control unit 106 to synchronize event information. In response to the synchronization instruction, the synchronization control unit 106 synchronizes a portion of the event information stored in the monitoring device determined in operation S72 with event information stored in the monitoring device DCD. Here, the synchronization control unit 106 of the monitoring device DCD synchronizes a portion of event information stored in the monitoring device determined in operation S72 with the event information of the monitoring target device ADD stored in the monitoring device DCD. Synchronization of the operation S73 is illustrated in FIG. 17.

Operation S74: The synchronization control unit 106 of the monitoring device DCD updates event holding device information of the monitoring device DCD, by adding information which associates an identifier of the monitoring target device ADD and an identifier of the monitoring device determined in operation S72 with each other, to the event holding device information stored in the monitoring device DCD. Then, the synchronization control unit 106 of the monitoring device DCD synchronizes event holding device information stored in other monitoring devices with the updated event holding device information. Description of the synchronization in operation S74 is omitted as being same as the synchronization described in operation S15 of FIG. 11.

Operation S75: The information control unit 101 of the monitoring device DCD determines whether there is a difference in the number of monitoring target devices allocated to each monitoring device. When there is no difference (S75: NO), the process ends. When there is a difference (S75: YES), the process proceeds to the operation S76. An example of this determination method is described.

The information control unit 101 of the monitoring device DCD determines, based on event holding device information stored in the monitoring device DCD, the number of monitoring target devices being monitored by each monitoring device. Then, the information control unit 101 of the monitoring device DCD determines a monitoring device monitoring a largest number of monitoring target devices, and a monitoring device monitoring a smallest number of monitoring devices. The monitoring device monitoring a largest number of monitoring target devices is a synchronization source monitoring device SRC. The monitoring device monitoring a smallest number of monitoring target devices is a synchronization destination monitoring device DST.

The information control unit 101 of the monitoring device DCD determines that there is a gap in the number of monitoring target devices allocated to each of monitoring devices when a difference between the number of monitoring target devices monitored by the monitoring device SRC and the number of monitoring target devices monitored by the monitoring device DST is larger than a predetermined number.

Here, when there is a gap in the number of monitoring target devices allocated to each of monitoring devices, a monitoring target device included in monitoring target devices monitored by the monitoring device SRC is shifted to a group of monitoring target devices monitored by the monitoring device DST (also referred to as device shift).

Operation S76: The information control unit 101 of the monitoring device DCD determines a monitoring target device to be shifted. The monitoring target device to be shifted is a monitoring target device whose allocation to monitoring devices is to be changed (from the monitoring device SRC to the monitoring device DST).

Specifically, the information control unit 101 of the monitoring device DCD determines, based on the event holding device information stored in the monitoring device DCD, one monitoring target device other than monitoring target devices monitored by the monitoring device DST from among monitoring target devices monitored by the monitoring device SRC. One monitoring target device determined in this manner is referred to as a monitoring target device to be shifted, as appropriate.

Here, assume that the first monitoring device W1 monitors the first monitoring target device M1, the second monitoring device W2 monitors the first, second, third, and fourth monitoring target devices M1, M2, M3, and M4, and the monitoring device W3 monitors the second, third, and fourth monitoring target devices M2, M3, and M4. In this assumption, the monitoring device SRC is, for example, the second monitoring device W2, and the monitoring device DST is, for example, the first monitoring device W1. In this assumption, the information control unit 101 of the monitoring device DCD determines, for example, the second monitoring target device M2 as a monitoring target device to be shifted, other than those managed by the monitoring device DST, from among monitoring target devices (M1 to M4) monitored by the monitoring device SRC.

Operation S77: The information control unit 101 of the monitoring device DCD transmits an instruction command to the monitoring device DST, where the instruction command instructs the monitoring device DST to monitor the monitoring target device to be shifted. The instruction command includes an identifier of the monitoring target device to be shifted. Upon receiving the instruction command, the information control unit 101 of the monitoring device DST transmits the instruction command to the event information management unit 105.

The information control unit 101 of the monitoring device DST transmits a command to a monitoring target device to be shifted, where the command instructs the monitoring target device to be shifted, to transmit the event information to the monitoring device DST. This command includes an identifier (for example, IP address) which uniquely identifies this monitoring target device in a network. In response to this command, the monitoring target device transmits event information to the monitoring device DST. The event information management unit 105 of the monitoring device DST acquires event information of the monitoring target device to be shifted.

Operation S78: The information control unit 101 of the monitoring device DCD instructs the monitoring device SRC to synchronize the event information. In response to the synchronization instruction, the synchronization control unit 106 of the monitoring device SRC synchronizes a portion of the event information of the monitoring device DST with event information of the monitoring target device to be shifted, which is stored in the monitoring device SRC. Synchronization processing of the operation S78 is illustrated in FIG. 17.

Operation S79: The information control unit 101 of the monitoring device DCD transmits an instruction command to the monitoring device SRC, where the instruction command instructs the monitoring device SRC to stop monitoring the monitoring target device to be shifted. The instruction command includes an identifier of the monitoring target device to be shifted. Upon receiving the instruction command, the information control unit 101 of the monitoring device SRC transmits the instruction command to the event information management unit 105. The event information management unit 105 of the monitoring device SRC acquires event information of the monitoring target device to be shifted.

Further, the event information management unit 105 deletes an event information record having an identifier of the monitoring target device to be shifted from event information stored in the monitoring device SRC.

Further, the information control unit 101 of the monitoring device SRC transmits a command to a monitoring target device to be shifted, where the command instructs the monitoring target device to be shifted, not to transmit the event information to the monitoring device SRC. This command includes an identifier (for example, IP address) which uniquely identifies this monitoring target device to be shifted in a network. In response to this command, the monitoring target device to be shifted does not transmit event information to the monitoring device SRC.

Operation S80: The information control unit 101 of the monitoring device DCD updates the event holding device information T4 stored in the monitoring device DCD by changing a monitoring device monitoring the monitoring target device to be shifted, and then synchronizes even holding device information T4 stored in other monitoring devices with the updated even holding device information T4.

Specifically, the information control unit 101 of the monitoring device DCD instructs the event holding device information management unit 104 to update the even holding device information T4. In response to the update instruction, the event holding device information management unit 104 deletes information which associates an identification symbol of the monitoring device SRC and an identifier of the monitoring target device to be shifted with each other, from the even holding device information T4 stored in the monitoring device DCD. In response to the update instruction, the event holding device information management unit 104 adds information which associates an identification symbol of the monitoring device DST and an identifier of the monitoring target device to be shifted with each other, to the event holding device information T4 stored in the monitoring device DCD.

Next, the synchronization control unit 106 of the monitoring device DCD synchronizes the updated event holding device information T4 with other monitoring devices. In other words, the synchronization control unit 106 of the second monitoring device W2 reflects the updated event holding device information T4 on event holding device information stored in other monitoring devices. Description of synchronization of the event holding device information T4 is omitted as being described in detail at the operation S15 of FIG. 11.

At the operation S76, the information control unit 101 of the monitoring device DCD determines a monitoring target device (with the state of “in operation”) other than those having the state information of “stopped” or “failure”, from among monitoring target devices monitored by the monitoring device SRC. This is because the monitoring target device to be shifted (determined monitoring target device) has to change the notification destination of the even information from the monitoring device SRC to the monitoring device DST. When the state of the monitoring target device to be shifted is “stopped” or “failure”, the monitoring target device is unable to change the notification destination of the event information. Therefore, at the operation S76, the information control unit 101 of the monitoring device DCD does not determine the monitoring target device whose state information indicates “stopped” or “failure”.

After ending the operation S80, the monitoring device DCD may return to processing of the operation S75 to repeat operations S76 to S80 until there is no gap in the number of monitoring target devices allocated to each of the monitoring devices (S75: No.).

According to the monitoring target equalization processing described above, the number of monitoring target devices monitored by monitoring devices may be equalized by adding or deleting a monitoring target device even when there is a change in the system configuration of monitoring target devices. Consequently, there is no increase of process load in a specific monitoring device.

(Synchronization Processing of Event Information)

Synchronization sequence of event information illustrated at operations S73 and S78 of FIG. 16 are described. Synchronization of the event information takes a time since the event information contains a large amount of information. Accordingly, an event information record to be preferentially synchronized is determined depending on the detail and time of the event information. The event information record to be preferentially synchronized is determined from the first and second points described below.

The first point is that when a failure has occurred, the user often refers to event information related to the failure. The second point is that when referring to event information during failure occurrence, the user often refers to current event information in order to grasp current failure status.

From the above first point, among event information of the synchronization target, an event information record containing the error as the event type is transmitted with a first priority (highest priority), then, an event information record containing the warning as the event type is transmitted with a second priority, and then, an event information record containing information other than error and warning as the event type is transmitted with a third priority.

Further, from the above first and second points, in order to enable the user to efficiently perform failure analysis, an event information record containing a time within a predetermined time span (for example, 3 minutes) from a time contained in an event information record with the event type of the error is transmitted with a first priority.

Further, from a third point, when the event type is same, an event information record containing a newer time (in other words, a time close to the current time) is transmitted preferentially.

FIG. 17 is a diagram illustrating an example of a synchronization sequence of event information, according to an embodiment. FIG. 17 illustrates operations S73 and S78 of FIG. 16.

Synchronization of event information at the operation S73 of FIG. 16 is illustrated in FIG. 17, in which the synchronization source monitoring device SRC is the determined monitoring device DCD, and the synchronization destination monitoring device DST is the monitoring device determined at the operation S72 of FIG. 16.

Synchronization of event information at the operation S78 of FIG. 16 is illustrated in FIG. 17, in which the monitoring target device ADD is the monitoring target device to be shifted, which is determined at the operation S76 of FIG. 16.

Operation S731: The synchronization control unit 106 of the synchronization source monitoring device SRC instructs the event information management unit 105 to acquire event information of the monitoring target device ADD (see S11 of FIG. 11) from event information T31 stored in the monitoring device SRC.

Operation S732: In response to the instruction, the event information management unit 105 of the synchronization source monitoring device SRC acquires event information of the monitoring target device ADD and sends it to the synchronization control unit 106. The synchronization control unit 106 discriminates between first event information and second event information to be transmitted with a second priority lower than a first priority, out of event information records of the acquired event information. Then, the synchronization control unit 106 adds an event information record of a first priority (that is, highest priority) as the first event information, to a queue Q1 (highest priority) of RAM 13.

Operation S733: The synchronization control unit 106 of the synchronization source monitoring device SRC adds an event information record of a priority lower than the first priority (that is, lower priority) as the second event information, to a queue Q2 (lower priority) of RAM 13.

When there are multiple monitoring target devices ADD, the synchronization control unit of the synchronization source monitoring device SRC performs processing of the operation S731 for the multiple monitoring target devices ADD.

Operation S734: The synchronization control unit 106 of the synchronization source monitoring device SRC transmits the event information record added to the queue Q1 (highest priority) of RAM 13 to the synchronization destination monitoring device DST.

Operation S735: The information control unit 101 of the synchronization destination monitoring device DST receives event information record transmitted from the synchronization source monitoring device SRC and transfers to the event information management unit 105. The event information management unit 105 stores the event information record in the monitoring device DST as event information.

Operation S736: The synchronization control unit 106 of the synchronization source monitoring device SRC transmits the event information record added to the queue Q2 (lower priority) of RAM 13 to the synchronization destination monitoring device DST.

Operation S737: The information control unit 101 of the synchronization destination monitoring device DST receives the event information record transmitted from the synchronization source monitoring device SRC and transfers to the event information management unit 105. The event information management unit 105 stores the event information record in the monitoring device DST as event information.

As illustrated in FIG. 16 and FIG. 17, the information control unit 101 of any monitoring device (for example, any of monitoring devices RND) in this embodiment determines, based on the event holding device information T4, whether at least two monitoring devices store event information of a same monitoring target device. When at least two monitoring devices do not store event information of a same monitoring target device, the information control unit 101 instructs a monitoring device other than the monitoring device RND to acquire event information of the same monitoring target device.

The synchronization control unit 106 of monitoring devices already storing event information of the same monitoring target device discriminates between the first and second event information out of the already stored event information of the same monitoring target device. Then, the synchronization control unit 106 transmits the first event information prior to the second event information to a monitoring device other than the monitoring devices already storing event information of the same monitoring target device.

According to the event information synchronization illustrated in FIG. 17, an event information record (with the type of “failure”) which is frequently referred to during trouble investigation is synchronized preferentially among event information to suppress effects due to synchronization delay. Accordingly, the user may promptly view event information records to be used in trouble investigation.

Further, according to this embodiment, even when a monitoring target device is added to or deleted from the information processing system SYS, monitoring devices may dynamically change allocation of monitoring target devices while assuring the redundancy. Then, monitoring devices may continue monitoring re-allocated monitoring target devices.

Dynamically changing the allocation of monitoring target devices enables the following two points. The first point is that irrespective of addition or deletion of a physical machine in a server consolidation environment and dynamic addition or deletion (or dynamic computer allocation) of a physical machine in a cloud environment, monitoring devices may continue monitoring while assuring the redundancy and monitoring capacity.

The second point is that it is unnecessary to manually re-design and re-structure the monitoring configuration. These two points reduces the number of monitoring operations by the user in the information system.

According to this embodiment, even if a gap in the number of monitoring target devices allocated to each of monitoring devices occurs among monitoring devices when a monitoring target device is added or deleted, optimization of allocation of the monitoring target devices to monitoring devices may be achieved in such a manner not concentrating the monitoring load to a specific monitoring device, while assuring the redundancy.

### Third Embodiment

### Addition of Monitoring Device

A monitoring device may be added to the information processing system SYS in order to enhance the redundancy of monitoring devices. Hereafter, a monitoring device added to the information processing system SYS is referred to as the added monitoring device as appropriate. When the monitoring device is added to the information processing system SYS, existing monitoring devices and the added monitoring devices synchronize configuration information, state information, event holding device information, and event information with each other.

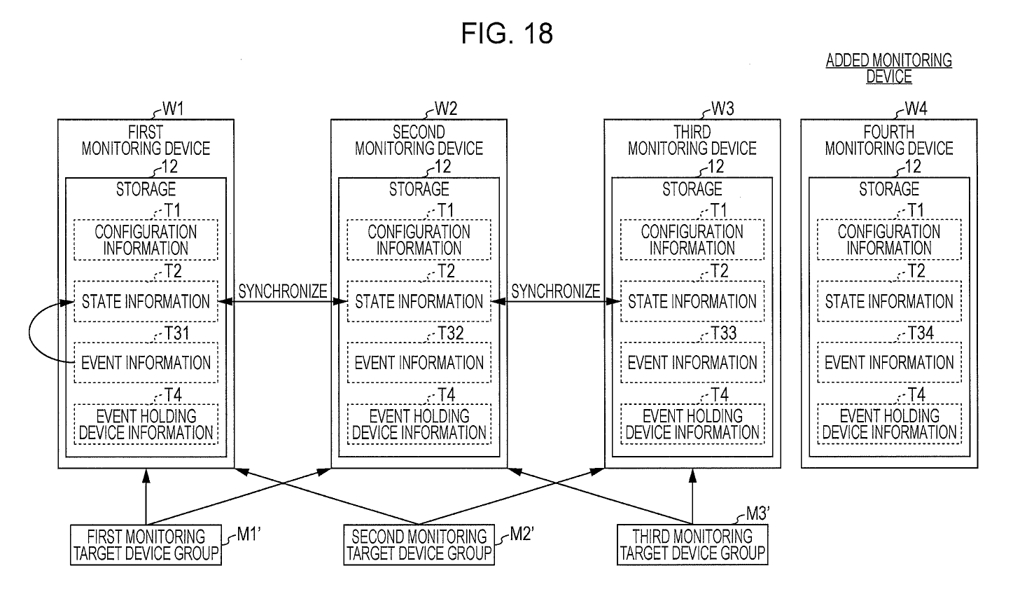

FIG. 18 is a schematic diagram illustrating an example of adding a monitoring device, according to an embodiment. In FIG. 18, the added monitoring device is, for example, the fourth monitoring device W4. In FIG. 18, to assure the redundancy of monitoring devices, the added monitoring device stores event information of monitoring target devices monitored by the other monitoring devices.

A first monitoring target device group M1′ represents multiple monitoring target devices monitored by the first monitoring device W1 and the second monitoring device W2. A second monitoring target device group M2′ represents multiple monitoring target devices monitored by the first monitoring device W1 and the third monitoring device W3. A third monitoring target device group M3′ represents multiple monitoring target devices monitored by the second monitoring device W2 and the third monitoring device W3.

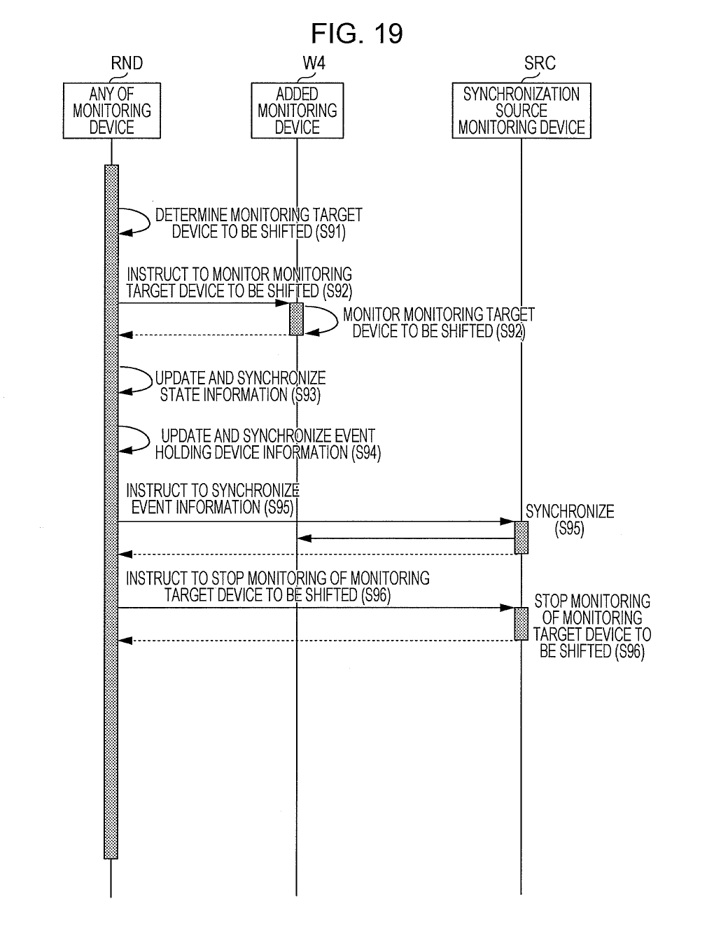

FIG. 19 is a diagram illustrating an example of an operational sequence for adding a monitoring device, according to an embodiment. Before performing the process illustrated in FIG. 19, the user operates the client terminal C1 to transmit an addition instruction command including an identifier of the added monitoring device to the information control unit 101 via the terminal interface unit 107 of any of monitoring devices RND in the information processing system SYS.

Operation S91: The information control unit 101 of the monitoring device RND determines a monitoring target device to be shifted. The monitoring device RND is, for example, the second monitoring device W2.

Specifically, the information control unit 101 of the monitoring device RND determines a monitoring device SRC that monitors the largest number of monitoring target devices, based on event holding device information stored in the monitoring device RND (see operation S75). The information control unit 101 of the monitoring device RND determines, based on event holding device information stored in the monitoring device RND, one monitoring target device out of monitoring target devices monitored by the monitoring device SRC (see operation S76). When determining the monitoring target device, the information control unit 101 of the monitoring device RND determines, based on configuration information stored in the monitoring device RND, a monitoring target device not having the dependency relationship.

Operation S92: The information control unit 101 of the monitoring device RND transmits an instruction command to the added monitoring device W4, where the instruction command instructs the added monitoring device W4 to monitor the monitoring target device to be shifted. The instruction command includes an identifier of the monitoring target device to be shifted. Upon receiving the instruction command, the information control unit 101 of the added monitoring device W4 transfers the instruction command to the event information management unit 105.

The information control unit 101 of the added monitoring device W4 transmits a command to a monitoring target device to be shifted so as to instruct the monitoring target device to be shifted, to transmit event information to the monitoring device W4. This command includes an identifier (for example, IP address) which uniquely identifies this monitoring target device in a network. In response to this command, the monitoring target device transmits event information to the monitoring device W4.

The event information management unit 105 of the added monitoring device W4 acquires event information of the monitoring target device to be shifted.

Operation S93: The information control unit 101 of the monitoring device RND updates event information stored in the monitoring device RND by changing a monitoring device monitoring the monitoring target device to be shifted, and then synchronizes event information stored in other monitoring devices with the updated event information stored in the monitoring device RND, where the other monitoring devices include the added monitoring device.

Specifically, the information control unit 101 of the monitoring device RND instructs the state information management unit 103 to update event information. In response to this update instruction, the state information management unit 103 deletes event information record including the identification symbol of the monitoring target device to be shifted, from event information stored in the monitoring device RND.

In response to the update instruction, the state information management unit 103 adds the identification symbol of the added monitoring device and the state “default”, to state information T2 stored in the monitoring device RND.

Next, the synchronization control unit 106 of the monitoring device RND synchronizes state information stored in the other monitoring devices with the updated event information T2.

Description of synchronization of the event information T2 is omitted here as being described in detail at the operation S14 of FIG. 11.

Operation S94: The information control unit 101 of the monitoring device RND updates the event holding device information T4 stored in the monitoring device RND by updating a monitoring device monitoring the monitoring target device to be shifted, and then synchronizes event holding device information T4 stored in other monitoring devices with the updated event holding device information T4, where the other monitoring devices include the added monitoring device.

Specifically, the information control unit 101 of the monitoring device RND instructs the event holding device information management unit 104 to update the even holding device information T4. In response to the update instruction, the event holding device information management unit 104 deletes an event holding device information record containing the identification symbol of the monitoring device SRC and the identifier of the monitoring target device to be shifted, from the event holding device information T4 stored in the monitoring device RND.

In response to the update instruction, the event holding device information management unit 104 adds information which associates an identification symbol of the added monitoring device W4 and an identifier of the monitoring target device to be shifted with each other, to the event holding device information T4 stored in the monitoring device RND.

Next, the synchronization control unit 106 of the monitoring device RND synchronizes event holding device information stored in the other monitoring devices with the updated event holding device information T4. Description of synchronization of the event holding device information T4 is omitted here as being described in detail at the operation S15 of FIG. 11.

Operation S95: The information control unit 101 of the monitoring device RND instructs the monitoring device SRC to synchronize event information. In response to the synchronization instruction, the synchronization control unit 106 of the monitoring device SRC synchronizes event information stored in the added monitoring device W4 with the event information of the monitoring target device to be shifted, which is stored in the monitoring device RND. For the synchronization of the operation S95, see FIG. 17.

Operation S96: The information control unit 101 of the monitoring device RND transmits an instruction command to the monitoring device SRC, where the instruction command instructs the monitoring device SRC to stop monitoring of the monitoring target device to be shifted. Processing performed by the monitoring device SRC after receiving this instruction command is described at the operation S79.

After end of the process of FIG. 19, the information control unit 101 of the monitoring device RND may perform processing at the operation S75 and subsequent operations of FIG. 16 until there is no gap in the number of monitored devices allocated to each of monitoring devices (see S75 of FIG. 16). In this case, processing at the operation S75 and subsequent operations is performed by the monitoring device RND instead of the monitoring device DCD of FIG. 16.

According to the monitoring device addition processing illustrated in FIG. 19, when a user instructs the monitoring device RND to add a monitoring device, the information processing system SYS automatically achieve monitoring of monitoring target devices by the added monitoring device W4 while assuring the redundancy of monitoring devices.

(Deletion of Monitoring Device)

A monitoring device may be deleted from the information processing system SYS due to a failure or periodical inspection of the monitoring device. That is, one or more monitoring devices may be separated from the information processing system SYS. Hereinafter, a monitoring device deleted from the information processing system SYS is referred to as the to-be-deleted monitoring device as appropriate. When the monitoring device is deleted from the information processing system SYS, existing monitoring devices and the to-be-deleted monitoring device synchronize configuration information, state information, event holding device information, and event information with each other.

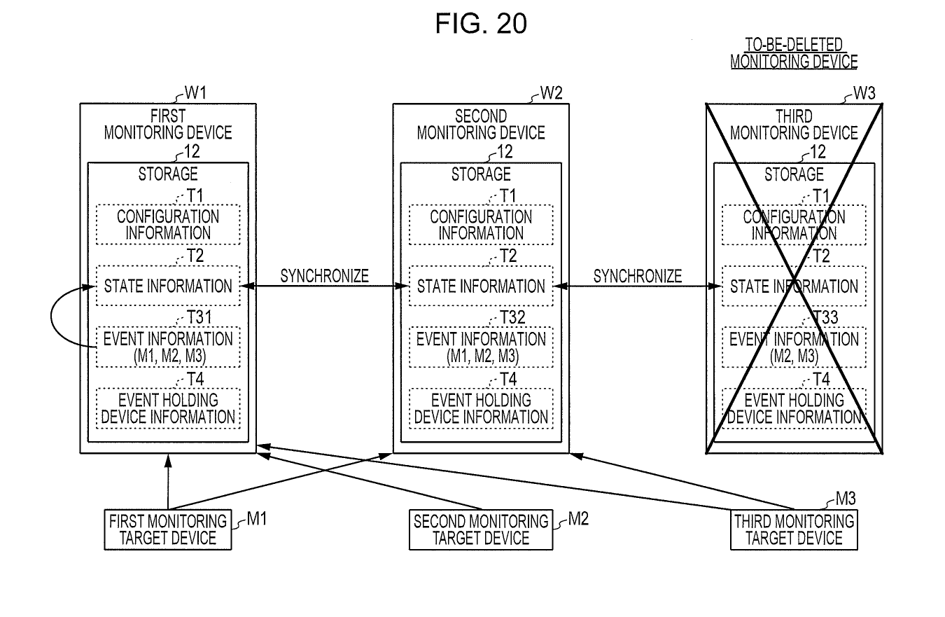

FIG. 20 is a schematic diagram illustrating an example of deletion of a monitoring device, according to an embodiment. FIG. 20 schematically illustrates a state in which one monitoring device is deleted from monitoring devices and monitoring target devices in a state illustrated in FIG. 9. In FIG. 20, the to-be-deleted monitoring device is, for example, the third monitoring device W3.

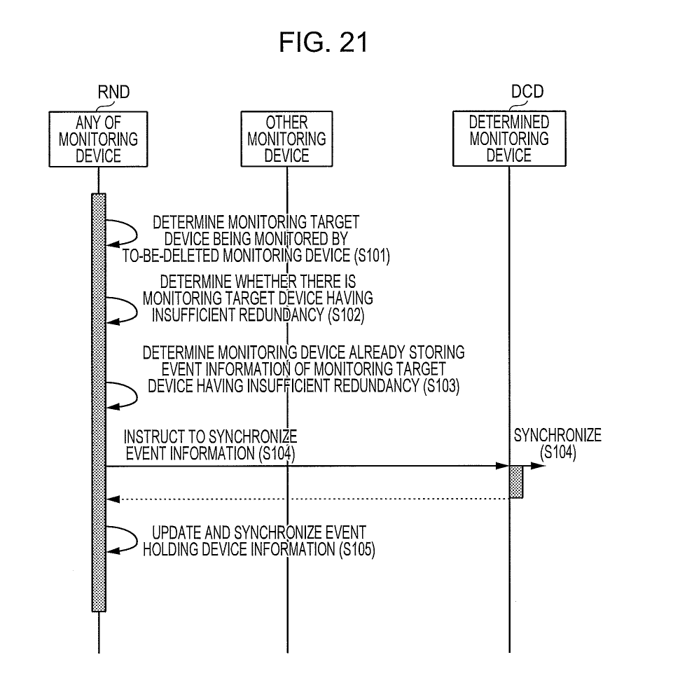

FIG. 21 is a diagram illustrating an example of an operational sequence for deletion of a monitoring device, according to an embodiment. Before the processing illustrated in FIG. 21, the user operates the client terminal C1 to transmit a deletion instruction command including an identifier of the to-be-deleted monitoring device to the information control unit 101 via the terminal interface unit 107 of the monitoring device RND.

Operation S101: The information control unit 101 of the monitoring device RND determines, based on event holding device information stored in the monitoring device RND, a monitoring target device monitored by the to-be-deleted monitoring device. In the example of FIG. 20, the information control unit 101 of the monitoring device RND determines the second monitoring target device M2 and the third monitoring target device M3 as monitoring target devices monitored by the to-be-deleted monitoring device W3.

Operation S102: The information control unit 101 of the monitoring device RND determines, based on event holding device information stored in the monitoring device RND, whether there is a monitoring target device having insufficient redundancy. The specific example of determination is described at the operation S71, and description thereof will be omitted here. In the example of FIG. 20, monitoring target devices having insufficient redundancy are the second monitoring target device M2 and the third monitoring target device M3.

Operation S103: The information control unit 101 of the monitoring device RND determines, based on event holding device information stored in the monitoring device RND, a monitoring device already storing event information of the monitoring target device having insufficient redundancy.

In the example of FIG. 20, the second monitoring device W2 stores event information of the third monitoring target device M3 which has insufficient redundancy, and the first monitoring device W1 stores event information of the second monitoring target device M2 which has insufficient redundancy.

Therefore, the information control unit 101 of the monitoring device RND determines the first monitoring device W1 as a monitoring device which stores event information of the second monitoring target device M2. Then, the information control unit 101 of the monitoring device RND determines the second monitoring device W2 as a monitoring device which stores event information of the third monitoring target device M3.

Hereafter, the monitoring device determined at the operation S103 is referred to as the monitoring device DCD (see operations S12 and S18 in FIG. 11) illustrated in the operation S71 of FIG. 16.

Operation S104: The information control unit 101 of the monitoring device RND instructs the monitoring device DCD to synchronize event information.

Specifically, the information control unit 101 of the monitoring device RND transmits a synchronization instruction command of event information to the monitoring device DCD.

The information control unit 101 of the monitoring device DCD determines, based on event holding device information stored in the monitoring device DCD, a monitoring device to store event information of a monitoring target device having insufficient redundancy, out of monitoring devices other than the monitoring device already storing event information of the device having insufficient redundancy. Hereinafter, the determined monitoring device is referred to as the synchronization destination monitoring device as appropriate.

The information control unit 101 of the monitoring device DCD instructs the synchronization control unit 106 to synchronize event information. In response to the synchronization instruction, the synchronization control unit 106 synchronizes a portion of event information stored in the synchronization destination monitoring device with event information of a monitoring target device monitored by the to-be-deleted monitoring device W3, which is stored in the monitoring device DCDf.

In the example of FIG. 20, the monitoring devices DCD are the first monitoring device W1 and the second monitoring device W2.

The information control unit 101 of the monitoring device RND transmits a synchronization instruction command of event information to the monitoring device DCD (for example, first monitoring device W1).

The information control unit 101 of the first monitoring device W1 determines, based on event holding device information stored in the monitoring device W1, a synchronization destination monitoring device (for example, second monitoring device W2) which stores event information of the second monitoring target device M2 having insufficient redundancy.

The information control unit 101 of the first monitoring device W1 instructs the synchronization control unit 106 to synchronize the event information. In response to the synchronization instruction, the synchronization control unit 106 synchronizes a portion of event information of the synchronization destination monitoring device (for example, second monitoring device W2) with event information of the second monitoring target device M2 monitored by the to-be-deleted monitoring device W3, which is stored in the monitoring device W1. Detail of the synchronization is illustrated at the operation S74 of FIG. 16.

In the example of FIG. 20, when the monitoring device RND is identical to the monitoring device DCD, the monitoring device RND performs the same processing as the monitoring device DCD. In the example of FIG. 20, the monitoring device RND and the monitoring device DCD serve as a same second monitoring device W2.

The information control unit 101 of the second monitoring device W2 determines, based on event holding device information stored in the monitoring device W2, a synchronization destination monitoring device (for example, first monitoring device W1) which stores event information of the third monitoring target device M3 having insufficient redundancy.

The information control unit 101 of the second monitoring device W2 instructs the synchronization control unit 106 to synchronize event information. In response to the synchronization instruction, the synchronization control unit 106 synchronizes event information of the synchronization destination monitoring device (for example, first monitoring device W1) with event information of the third monitoring target device M3 monitored by the to-be-deleted monitoring device W3, which is stored in the monitoring device W2. Detail of the synchronization is illustrated at the operation S74 of FIG. 16.

Operation S105: The information control unit 101 of the monitoring device RND instructs the event holding device information management unit 104 to delete event holding device information of the monitoring target device determined at the operation S101. In response to this instruction, the event holding device information management unit 104 updates event information by deleting the event holding device information record having the identifier of the deleted monitoring target device from the event holding device information stored in the monitoring device RND.

The information control unit 101 instructs the synchronization control unit 106 to synchronize event holding device information. In response to the synchronization instruction, the synchronization control unit 106 synchronize event holding device information stored in the other monitoring devices with the updated event holding device information. The synchronization performed by the information control unit 101 of the monitoring device RND and specific example of the synchronization performed by the synchronization control unit 106 are described at the operation S25, and description thereof will be omitted here.

In the example of FIG. 20, the event holding device information management unit 104 of each of the first monitoring device W1 and the second monitoring device W2 deletes, from the event holding device information T4, event holding device information records which associates an identifier of the third monitoring device W3 and an identifier of the second monitoring target device M2 with each other, and event holding device information records which associates an identifier of the third monitoring device W3 and an identifier of the third monitoring target device M3 with each other.

After ending the process of FIG. 21, the information control unit 101 of the monitoring device RND may perform processing of the operation S75 and subsequent operations of FIG. 16 until there is no gap in the number of monitored devices allocated to each of monitoring devices (see S75 of FIG. 16). In this case, processing at the operation S75 and subsequent operations is performed by the monitoring device RND instead of the monitoring device DCD of FIG. 16.

According to the monitoring device deletion processing illustrated in FIG. 21, when a user instructs the monitoring device RND to delete a monitoring device, the information processing system SYS automatically achieve monitoring of monitoring target devices by existing monitoring devices while assuring the redundancy of monitoring devices. As a result, manual re-designing and re-structuring of the monitoring configuration may not be performed, and thereby the number of monitoring operations by the user in the information system may be reduced.

As described above, according to this embodiment, even when a monitoring device is added to or deleted from the information processing system SYS, monitoring devices may dynamically change allocation of monitoring target devices to monitoring devices while assuring the redundancy. As a result, the monitoring device may continue monitoring while assuring the redundancy and monitoring capacity.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of monitoring target devices; and
a plurality of monitoring devices each configured to monitor one or more monitoring target devices allocated to the each monitoring device, wherein
a first monitoring device among the plurality of monitoring devices is configured to:
acquire monitor information from the one or more monitoring target devices allocated to the first monitoring device;
store the acquired monitor information in a first memory provided for the first monitoring device; and
when transmitting the monitor information stored in the first memory to a second monitoring device among the plurality of monitoring devices, control transmission of the monitor information so that first monitor information that is the monitor information having a high priority and identified based on a type of the monitor information is transmitted in priority to second monitor information that is the monitor information other than the first monitor information.

2. The information processing system of claim 1, wherein
the second monitoring device is configured to:
store the transmitted monitor information in a second memory of the second monitoring device, and
perform synchronization of the monitor information so that the monitor information stored in the second memory matches with the monitor information stored in the first memory of the first monitoring device that has transmitted the monitor information.

3. The information processing system of claim 1, wherein
the monitor information includes, as the first monitor information, state information indicating state of each of the plurality of monitoring target devices, and event information indicating an event occurring in each of the plurality of monitoring target devices.

4. The information processing system of claim 3, wherein
the event information includes a type of event occurring in each monitoring target device, and
the first monitoring device is configured to:
discriminate, based on the type of event, between first event information transmitted with a first priority and second event information transmitted with a second priority lower than the first priority, and
control transmission of the monitor information so that the first event information is transmitted to the second monitoring device in priority to the second event information.

5. The information processing system of claim 4, wherein
each monitoring device stores, in a memory provided therefor, holding device information that associates an identifier identifying each of the one or more monitoring target devices with an identifier identifying a monitoring device that stores event information of the each monitoring target device;
a third monitoring device having event information of a first monitoring target device determines, based on the holding device information thereof, whether at least two monitoring devices store event information of the first monitoring target device;
when at least two monitoring devices do not store event information of the first monitoring target device, the first monitoring device instructs a fourth monitoring device other than the third monitoring device to acquire event information of the first monitoring target device; and
the third monitoring device already storing event information of the first monitoring target device discriminates between the first and second event information out of the already stored event information of the first monitoring target device, and controls transmission of the monitor information so that the first event information is transmitted to the fourth monitoring device, in priority to the second event information.

6. The information processing system of claim 5, wherein
when a second monitoring target device is newly added to the information processing system, a fifth monitoring device already storing event information of the second monitoring target device discriminates between the first and second event information of the already stored event information of the second monitoring target device, and controls transmission of the monitor information so that the first event information is transmitted to a sixth monitoring device other than the fifth monitoring device, in priority to the second event information.

7. The information processing system of claim 6, wherein
the fifth monitoring device is configured to:
when the second monitoring target device is newly added to the information processing system, store, in a memory provided therefor, the holding device information that further includes an identifier identifying the added second monitoring target device and an identifier identifying each of one or more monitoring devices storing event information of the added second monitoring target device;
store, in the memory thereof, the state information further including state information of the added second monitoring target device; and
control transmission of the monitor information so that the state information of the added second monitoring target device and the holding device information, which includes an identifier of the added second monitoring target device and identifiers of one or more monitoring devices storing event information of the added second monitoring device, are transmitted to the sixth monitoring device.

8. The information processing system of claim 5, wherein
when a second monitoring target device is deleted from the information processing system, a fifth monitoring device having event information of the second monitoring target device:
transmits, to monitoring devices other than the fifth monitoring device, an instruction signal for deleting state information and holding device information of the second monitoring target device; and
transmits, to a sixth monitoring device already storing event information of the second monitoring target device, an instruction signal for deleting the event information of the second monitoring target device.

9. The information processing system of claim 5, wherein
in a case where a third monitoring device is newly added to the information processing system, a fourth monitoring device that is any one of the plurality of monitoring device:
controls transmission of the monitoring information so that state information already stored in a memory provided the fourth monitoring device is transmitted to the third monitoring device,
determines, based on the holding device information, one or more monitoring target devices to be monitored by the second monitoring device, and
controls transmission of the monitor information so that holding device information including identifiers identifying the determined one or more monitoring target devices and an identifier identifying the second monitoring device is transmitted to monitoring devices other than the each monitoring device; and
a fifth monitoring device already storing event information of the second monitoring target device discriminates between the first and second event information out of the event information already stored in the fifth monitoring target device, and controls transmission of the monitor information so that the first event information is transmitted, to the second monitoring device, in priority to the second event information.

10. The information processing system of claim 5, wherein
in a case where a third monitoring device is deleted from the information processing system, a fourth monitoring device already storing event information pertaining to the third monitoring device discriminates between the first and second event information out of the event information pertaining to the third monitoring device, which is stored in the fourth monitoring device, and controls transmission of the monitor information so that the first event information is transmitted, in priority to the second event information, to monitoring devices other than monitoring devices already storing event information pertaining to the third monitoring device.

11. A monitoring device in an information processing system including a plurality of monitoring target devices, and a plurality of monitoring devices each configured to monitor one or more monitoring target devices among the plurality of monitoring target devices, the monitoring device comprising:
a memory; and
a processor coupled to the memory, wherein
the processor is configured to:
acquire monitor information from a first monitoring target device allocated to the first monitoring device,
store the acquired monitor information in the memory, and
when transmitting the monitor information stored in the memory to another monitoring device among the plurality of monitoring devices, control transmission of the monitor information so that first monitor information that is the monitor information having a high priority and identified based on a type of the monitor information is transmitted in priority to second monitor information that is the monitor information other than the first monitor information.

12. A monitoring method performed by an information processing system including a plurality of monitoring target devices, and a plurality of monitoring devices each configured to monitor one or more monitoring target devices allocated to the each monitoring device, the monitoring method comprising:
causing each of the plurality of monitoring devices to:
acquire monitor information from the one or more monitoring target devices allocated to the each monitoring device,
store the acquired monitor information in a memory provided for the each monitoring device, and
when transmitting the monitor information stored in the memory to a monitoring device other than the each monitoring device, control transmission of the monitor information so that first monitor information that is the monitor information having a high priority and identified based on a type of the monitor information is transmitted in priority to second monitor information that is the monitor information other than the first monitor information.

13. A non-transitory, computer-readable recording medium having stored therein a program for causing a computer included in a monitoring device, to execute a process comprising:
acquiring monitor information from one or more monitoring target devices allocated to the monitoring device;
storing the acquired monitor information in a memory coupled to the processor; and
when transmitting the monitor information stored in the memory to another monitoring device, controlling transmission of the monitor information so that first monitor information that is the monitor information having a high priority and identified based on a type of the monitor information is transmitted in priority to second monitor information that is the monitor information other than the first monitor information.
